(19) United States
(12) Patent Application Publication
(10) Pub. No.: US 2013/0206491 A1
(43) Pub. Date: Aug. 15, 2013

(54) Vehicle

(71) Applicants: James Kor, Winnipeg (CA); Bruce Sewart, Winnipeg (CA); Jim Shewchuk, Winnipeg (CA); Ken Butt, Winnipeg (CA); John Vukelic, Winnipeg (CA); Blaine McFarlane, Winnipeg (CA); Terry Halajko, Winnipeg (CA); David Berhardt, Winnipeg (CA); Jack Slivinski, Winnipeg (CA); Jim Dunn, Winnipeg (CA)

(72) Inventors: James Kor, Winnipeg (CA); Bruce Sewart, Winnipeg (CA); Jim Shewchuk, Winnipeg (CA); Ken Butt, Winnipeg (CA); John Vukelic, Winnipeg (CA); Blaine McFarlane, Winnipeg (CA); Terry Halajko, Winnipeg (CA); David Berhardt, Winnipeg (CA); Jack Slivinski, Winnipeg (CA); Jim Dunn, Winnipeg (CA)

(73) Assignee: KOR ECOLOGOIC INC., Winnipeg, MB (CA)

(21) Appl. No.: 13/809,779

(22) PCT Filed: Jul. 12, 2011
(86) PCT No.: PCT/CA2011/050425

§ 371 Date: Mar. 12, 2013

Related U.S. Application Data
(60) Provisional application No. 61/363,533, filed on Jul. 12, 2010.

(51) Int. Cl. B60K 6/44

(52) U.S. Cl. CPC B60K 6/44; Y10S 903/903
USPC 180/65.225; 180/54.1; 903/903

(57) ABSTRACT

A vehicle includes a highly aerodynamic body for two passengers side by side with two non-steering front wheels spaced apart across the body and covered by exterior panes and a single rear steering ground wheel The bottom panel is planar and the rear wheel is carried in a disk in the plane which rotates to steer with a self centering cam. A hybrid drive system includes batteries and ultra-capacitors charged by regeneration operated by a separate foot pedal. The body includes a full width door that hinges at the front 45 and opens to near vertical to allow the passengers to step over the frame onto the floor in front of the seat with the steering wheel and pedals moved away. Wiring is contained in flat compartments in the interior walls. The batteries are contained in a temperature controlled container located at the front which also acts as a crush zone.

This invention relates to a vehicle which is designed, as far as possible, using the least possible energy for movement, within an automobile, so that this energy, when low enough, can ideally and feasibly come from renewable sources at a practical scale. The concept therefore is to learn to use the least energy possible

### SUMMARY OF THE INVENTION

The invention provides a number of different aspects which can be used independently as defined hereinafter or can be used in conjunction with one another to provide best advantage.

### Body

According to one aspect of the invention there is provided a vehicle comprising:

a vehicle body defining an enclosure of one or more passengers;

ground wheels including at least one non-steering ground wheel and at least one steering ground wheel;

a power generation system;

a power transmission system from the power generation system to one or more of the wheels;

the body including rounded upper and lower side-edges of body, allowing sharing of air between four sides of car body as air travels over body, from front to rear.

Preferably in this aspect, the steering ground wheel is located at the rear which allows two non-steering front ground wheels to be close to the outside edge of body, giving the car a wide stance.

Preferably in this aspect, the steering ground wheel has a tire which projects through only a slot in a support disk with the entire disc with the slot in it rotating about an upright axis in order to steer.

Preferably in this aspect, the front wheels are non-steering and are covered on the sides to a position at the bottom of the body.

Preferably in this aspect, a cam provides self centering of the steering ground wheel.

Preferably in this aspect, cam pressure of the cam is adjustable to reduce self centering at low speed.

### Hybrid

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

wherein the generation and transmission system comprises a hybrid drive system including an IC engine, electric motors where the electric motors are sized for acceleration and low-speed cruising, while the IC engine and fuel tank therefor are sized for high speeds and long-distance driving.

Preferably in this aspect, the electric power is stored in a combination of batteries and ultra-capacitors.

Preferably in this aspect, the ultra-capacitors absorb energy primarily during regenerative braking and on downhill runs, and they release this energy during vehicle acceleration or hill-climbing.

Preferably in this aspect, the ultra-capacitors buffer the current seen by the batteries, making the batteries last significantly longer before needing replacement.

Preferably in this aspect, the engine is used either to drive a generator for electric storage or to directly drive one wheel for long distance cruising speed travel and the electric motors are used for acceleration and low speed travel.

Preferably in this aspect, the electric motors each drive one wheel though a chain drive and the IC motor drives one of the wheels through a chain drive.

Preferably in this aspect, the engine and emission system is pre-heated from stored electrical power so that the engine starts at efficient warmed condition.

### Passenger Entry

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

wherein the body includes a full width door that hinges at the front 45 and opens to near vertical or past vertical;

wherein the canopy is cut low on side of car so as to provide low threshold for person to step over;

wherein the floorboard is arranged relative to the seat so that the first step is directly onto the flat floorboard in front of the seat;

and wherein a steering wheel is arranged to move from its position in front of the seat.

Preferably in this aspect, the steering wheel is arranged to pivot about an axis longitudinal of the vehicle and offset from the rotation axis of the wheel.

Preferably in this aspect, a linkage carrying the steering shaft includes an arm which can fold upwards to allow the driver to stand up from the seat for exit.

Preferably in this aspect, the passengers are seated in a cage which extends in front of them, over their heads and to the sides of them which entrance through a door entry which lifts up allowing them to step over the sides of the cage onto the floor.

Preferably in this aspect, the seat is fixed fore and aft.

Preferably in this aspect, the seat includes a lifting seat bottom panel.

Preferably in this aspect, the vehicle includes foot pedals for actuation by the driver where the pedals are mounted on an adjustable pedal carriage.

### Batteries

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

wherein the batteries are stored in an insulated heated container.

Preferably in this aspect, the batteries are mounted in a front mounted battery compartment with crush zones.

Preferably in this aspect, additional batteries are located behind the seat.

### Wiring

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

wherein the vehicle includes a wiring system having bus bars and wiring and labels

and wherein interior surfaces of the vehicle body include cavities that contain the bus bars and wiring and labels with each cavity having a cover.

Preferably in this aspect, the cavities in the surfaces are connected each to the next by ducts that wiring harnesses fit through with the harnesses then being spread within the cavities for connection to the bus bars.

Preferably in this aspect, the bus bars allow electrical measurement at all critical junctions, and allow quick disconnection of wires at these junctions.

### Cover

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

wherein the body includes an large upper window or windows;

and wherein there is provided a cover over the window or windows from the outside of an opaque material where the cover rolls up on roll in the vehicle.

Preferably in this aspect, the roll is located in the front of the vehicle under the hood.

Preferably in this aspect, the hood tips open forward to expose the roll and allow the blanket to unroll to rear of the vehicle.

Preferably in this aspect, the cover comprises a solar panel.

### Regeneration

According to one aspect of the invention there is provided a vehicle comprising:

a vehicle body defining an enclosure of one or more passengers;

ground wheels including at least one non-steering wheel and at least one steering wheel;

a power generation system;

a power transmission system from the power generation system to one or more of the wheels;

the power generation system including an alternator driven by the wheels to regenerate power when the vehicle is slowing;

wherein there is provided a regeneration pedal separate from an accelerator pedal and from a brake pedal which activates the alternator to regenerate power slowing the vehicle

Preferably in this aspect, the accelerator pedal is arranged to allow the vehicle to freewheel when released.

Preferably in this aspect, the regeneration pedal, brake pedal and accelerator pedal are commonly mounted on a movable carriage.

### Vehicle Layout

According to one aspect of the invention there is provided a vehicle comprising:

a vehicle body defining an enclosure of one or more passengers;

ground wheels including at least one non-steering wheel and at least one steering wheel;

a power generation system including a battery pack;

a power transmission system from the power generation system to one or more of the wheels;

wherein the battery pack is mounted in a front mounted battery compartment with crush zones.

Preferably in this aspect, additional batteries are located behind a seat

Preferably in this aspect, electric motors driving the front wheels are located under the seat.

### DESCRIPTION OF THE DRAWINGS

Embodiments of the invention are described hereinafter in conjunction with the accompanying drawings in which:

FIG. 1 is a schematic isometric view from the top and one side of a vehicle according to the invention.

FIG. 2 is a schematic isometric view from the bottom and rear of the vehicle of FIG. 1.

FIG. 3 is a layout of the propulsion system of the vehicle.

FIG. 4 is an isometric view of a front part of the vehicle of FIG. 1 showing the door in open position for entry of the driver.

FIG. 5 is a top plan view of the rear steering wheel and support disk of the vehicle of FIG. 1 showing the disk in centered position.

FIG. 6 is a top plan view of the rear steering wheel and support disk of the vehicle of FIG. 1 showing the disk in steered position.

FIGS. 7 to 20 show the drive train of FIG. 3 in various modes as required for driving the vehicle.

FIG. 21 is an exploded view of the rear steering wheel and support disk of the vehicle of FIG. 1.

FIG. 22 is an exploded view of one ground wheel of the vehicle of FIG. 1.

FIG. 23 is an exploded view of one ground wheel and the drive components thereto of FIG. 3 of the vehicle of FIG. 1.

FIG. 24 is view of the steering system of the vehicle of FIG. 1.

FIG. 25 is an exploded view of the battery housing of the vehicle of FIG. 1.

FIG. 26 is an exploded view of the lower panels of the vehicle of FIG. 1.

FIG. 27 is an exploded view of the internal components of the vehicle of FIG. 1.

FIG. 28 is an isometric view of the frame of the vehicle of FIG. 1 with the body panels and internal components removed.

FIG. 29 is an exploded view of the upper panels of the vehicle of FIG. 1.

FIG. 30 is an exploded view of one seat of the vehicle of FIG. 1.

FIG. 31 is a side elevational view of the vehicle of FIG. 1 showing the air flows.

FIG. 32 is an isometric view of the vehicle of FIG. 1 showing the air flows.

FIG. 33 is a bottom plan view of the vehicle of FIG. 1 showing the air flows.

FIG. 34 is an isometric view of the vehicle of FIG. 1 showing the air flows.

FIG. 35 is a rear elevational view of the vehicle of FIG. 1 showing the body surfaces.

FIG. 36 is side elevational view of the vehicle of FIG. 1 showing the front suspension.

FIG. 37 is a cross-sectional view of the vehicle of FIG. 1 along the lies 37-37 of FIG. 36.

FIG. 38 is a schematic plan view of the vehicle of FIG. 1 showing the heat management system in a cooling mode.

FIG. 39 is a schematic plan view of the vehicle of FIG. 1 showing the heat management system in a heating mode.

FIG. 40 is a schematic view of the vehicle of FIG. 38 showing the engine and exhaust system including a heat exchanger.

FIG. 41 is a schematic view of the heat exchanger of FIG. 40.

FIG. 42 is a schematic view of the battery pack and holder of the vehicle of FIG. 1.

FIG. 43 is a schematic view of the battery pack of the vehicle of FIG. 1 showing the cooling fins on the battery terminals.

FIG. 44 is a schematic view of the battery pack and holder of the vehicle of FIG. 1.

FIG. 45 is a schematic view of the battery pack and holder of the vehicle of FIG. 1.

FIG. 46 is a vertical cross-sectional view of the battery pack and holder of the vehicle of FIG. 1.

FIG. 47 is an exploded view of the battery pack and holder of the vehicle of FIG. 1.

FIG. 48 is a schematic view of the interior of the vehicle of FIG. 1 showing the covered cavities for the electrical components.

FIG. 49 is a schematic view of the interior of the vehicle of FIG. 1 showing the cavities for the electrical components with the covers removed.

FIG. 50 is a schematic view of examples of the electrical components of FIG. 49 showing the bus bar, cables and labels.

FIG. 51 is a schematic view of the cover carried on a roll for deployment over the exterior of the vehicle.

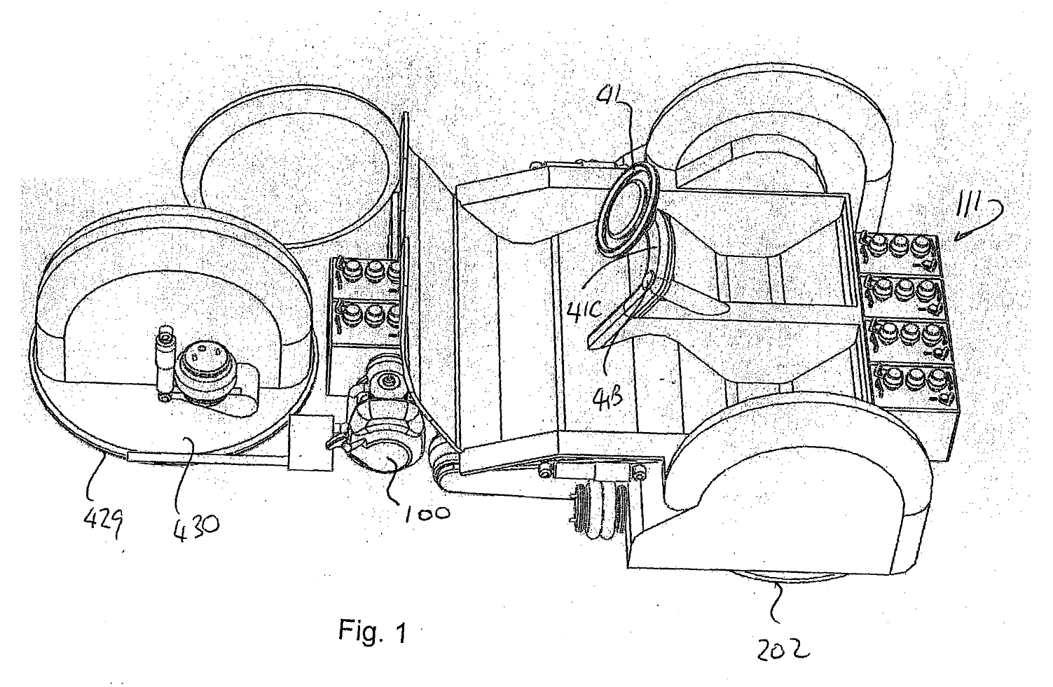

### DETAILED DESCRIPTION

### Aerodynamic Body

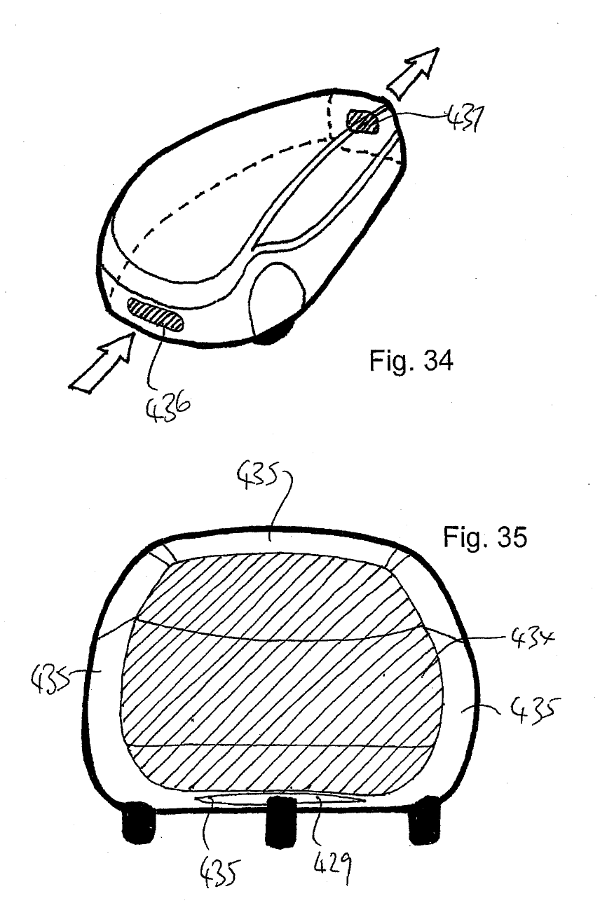

Turning firstly to FIGS. 31 to 35 there is shown the exterior arrangement of the body shape which provides very low air resistance.

It has been in the literature for over 100 years, regarding what generally an aerodynamic body should look like, when that body is travelling close to the ground, at speeds in the order of zero to 100 miles per hour. This information has been partially adopted in some land speed record cars, and some racing cars, but generally has not found its way fully if barely at all into passenger cars. This is largely because of two factors:

Passenger car bodies are designed to be appealing to look at, and to be fashionable through design efforts in styling, not necessarily for aerodynamic performance or for purely functional reasons.

Car engines are designed and chosen for acceleration to overcome the car's inertia resistance, and this makes engines so powerful that overcoming aerodynamic drag, even in the poorest design of body for example, a rectangular box, becomes an insignificant factor in the overall design criteria of the car.

So, we have witnessed a 100 years of cars, designed with bigger and bigger engines in an age of cheap and plentiful gasoline, where the science of aerodynamics has been largely ignored. If used at all, aerodynamics has been largely a marketing tool, in order to boast about more energy-efficient cars. But, the actual drag reductions have been marginal, largely due to a reluctance to adopt a scientific approach to achieving the shape of the car body based upon the physics of movement through air. Current strategy within car corporations remains a styling approach to the car body, where it is primarily a marketing approach used to sell cars by enhancing fashion and visual appeal.

The present arrangement as shown in FIGS. 31, 32 and 33 has the following features of the body 420:

fully enclosed side panels 421 covering the front wheels and tires 422;

smooth exterior with no projections such as mirrors;

tires 422 fit immediately inside the body with minimal gaps,

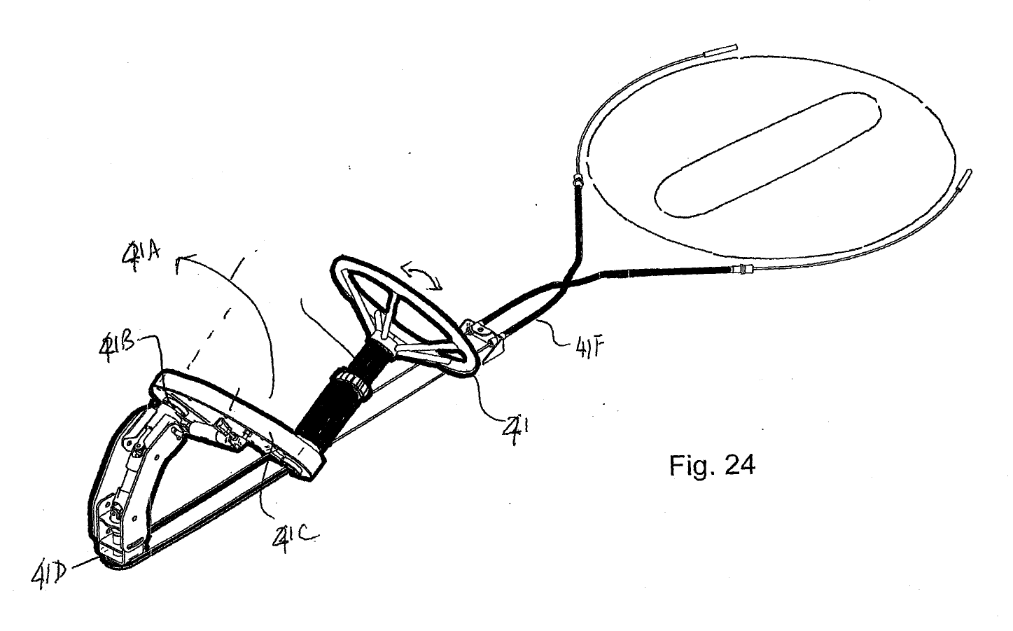

the steering wheel controls, as shown in FIG. 24 described hereinafter, projects through only slots in underside of body;

smooth underside 423 with no projections of recesses or operating components;

rounded upper 424 and lower 425 surfaces and side-edges 426 and 427 of the 420 body, allowing sharing of air between all four sides (top, bottom and sides) of car body as air travels over the body, from front to rear;

rear steering 428 of the rear wheel 429 allows the non-steering front wheels 422 to be close to the outside edge 421 of the body, giving the car a wide stance, which would not be possible if the front wheels steered as this would necessitate either body panels that move with the wheels, or having the wheels dramatically inset to allow for steering movement. Thus for example, many cars of the past, like the old Jaguar sports cars, did cover the rear wheels successfully because these do not steer, but avoided covering the steering wheels because of the problems cited;

covering by panels 421 of the body 420 of the front wheels is very similar to covering the rear wheels of the conventional car, and can be done easily;

rear wheel steering allows the rear tire 429 to project through only a slot in a circular disk or plate 430, because the entire disc 430 with a slot 431 for the tire in it rotates in order to steer. The disk sits in a circular opening 432 in the smooth bottom 423 so it does not interfere with the smooth flow over the bottom;

As shown in FIGS. 31 to 35, the aerodynamic body has the following important features:

It is the most aerodynamic way to enclose two seated persons sitting side-by-side in a vehicle. Rounded nose 424, 425 (in side view FIG. 31) induced tail 434 provided by the inwardly curved four surfaces 435 converging to the flattened rear surface 434, truncated tail 434 (Kam effect), invented by Prof. Kam in Germany, and smooth bottom 423.

FIG. 31—Sharing of air top and bottom (split at the nose) 424, 425. Gradual slope of these surfaces minimizes cavitation.

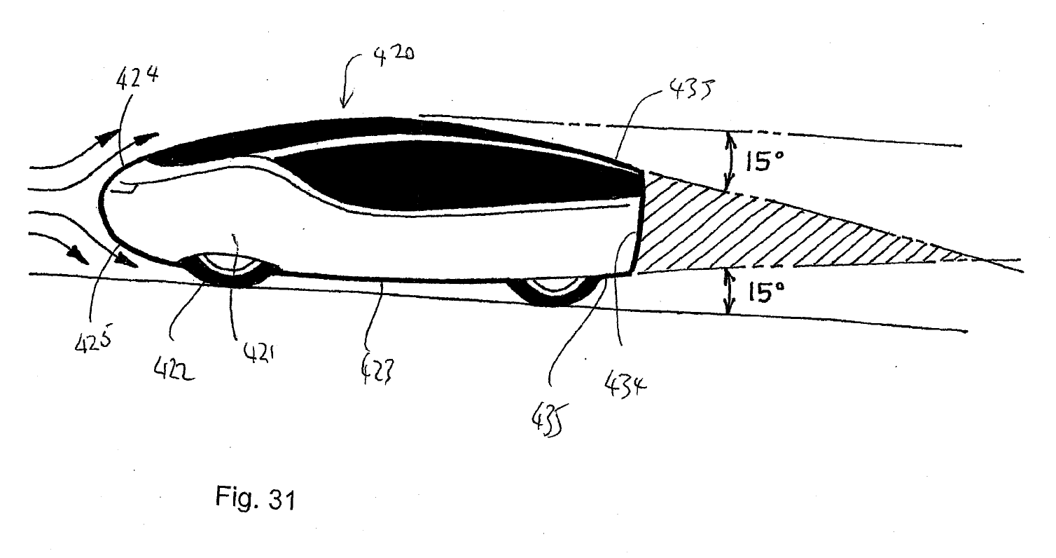

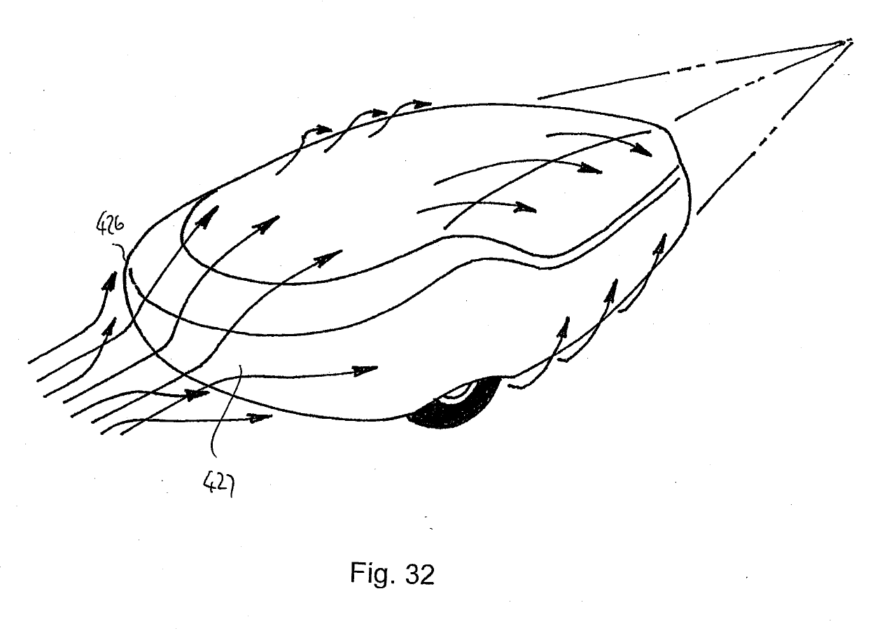

FIG. 32—sharing occurs between top and sides, and bottom and sides 424, 425, 426 and 427. Therefore, we need rounded edges here.

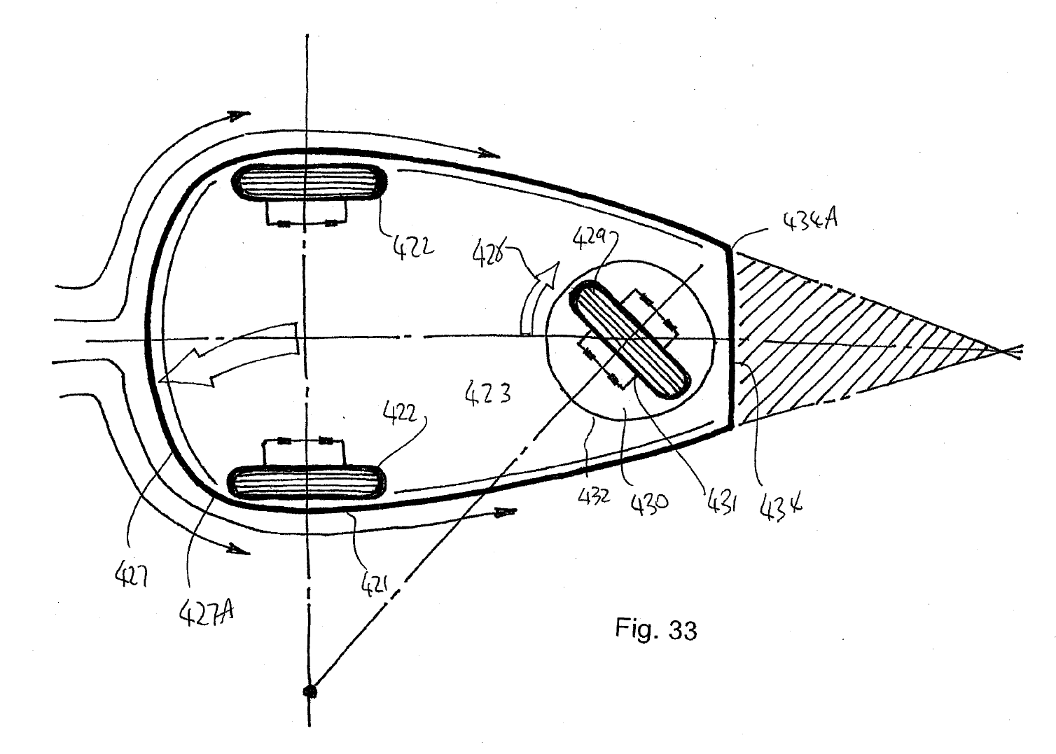

FIG. 33—This corner 427A at the front corners 426 and 427 is very important in that it has to be a large radius, so that separation from the vehicle surface does not occur. This air at the rear 434 is stagnant, and moves with the vehicle (the induced tail). This corner 434A at the rear 434 must be very sharp so that quick separation from the vehicle surface does occurs, and so that air does not want to “wrap around” onto the rear. Thus the front corner is much larger in radius than the rear corner

FIG. 33 shows that slot 431 rotates with rear steering. No gap change as ring 430 steers, thereby maintaining aerodynamics.

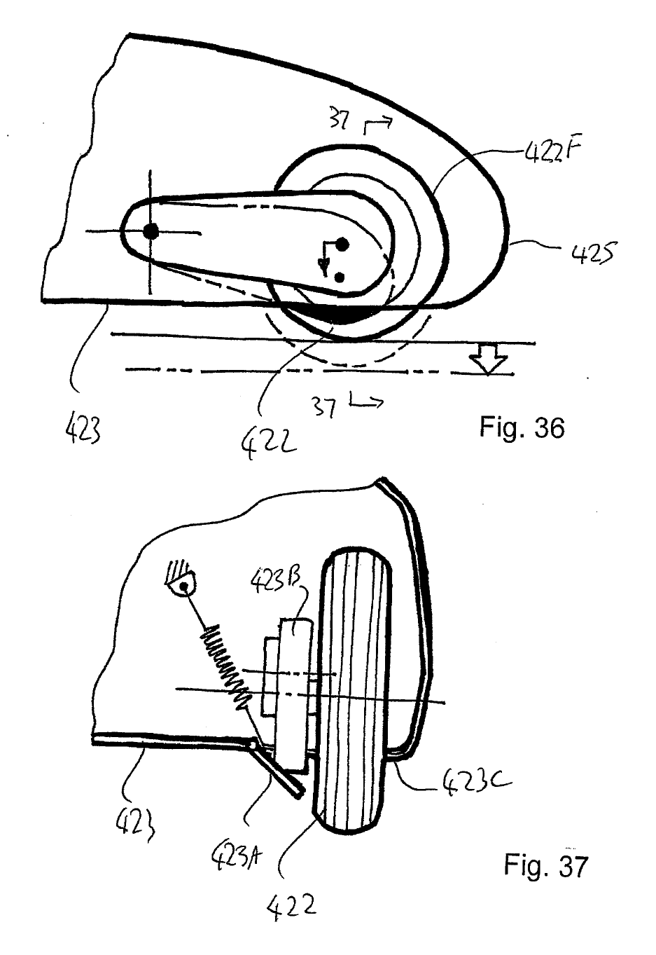

FIGS. 36 and 37 a moving flap 423A is provided at the bottom surface 42 to allow chain drive 423B to the front wheel 422 to move up and down to a position below the bottom wall. This provides a slightly bigger gap or space than the width of the wheel in order to handles suspension movement without interference. This provides a tight space or gap between tire 422 and slot 423C in the underside of body.

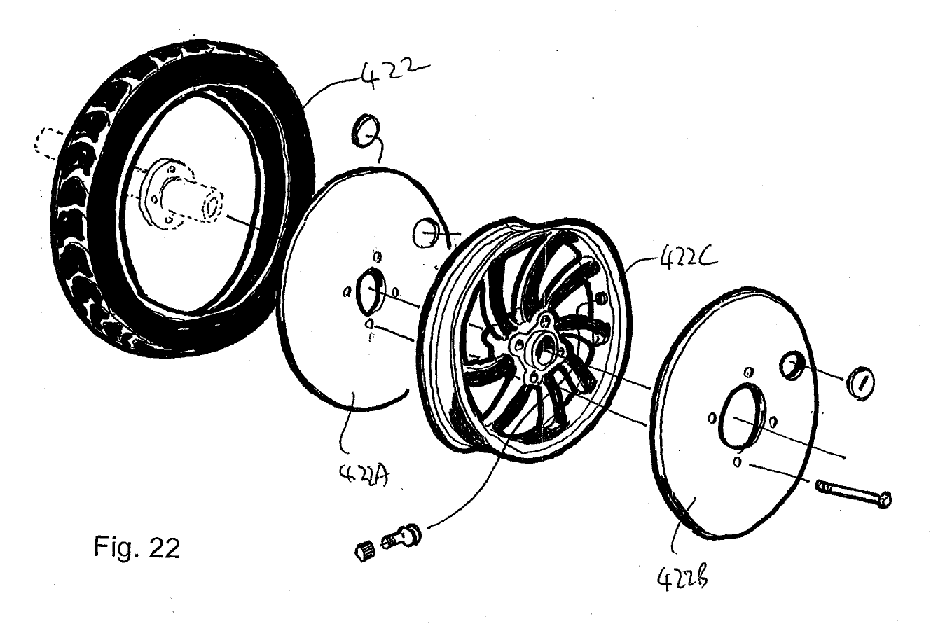

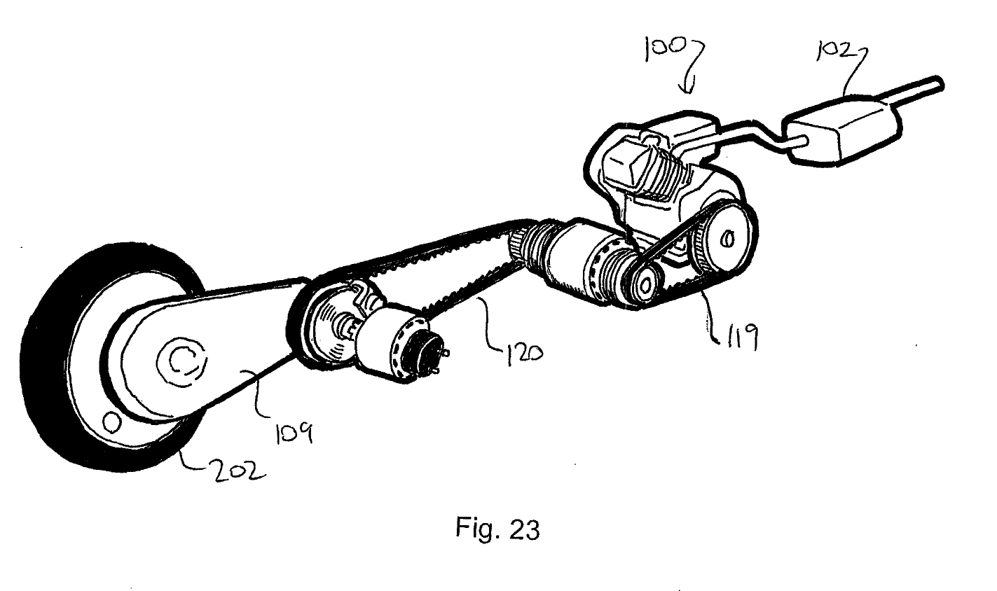

FIG. 22 shows that smooth discs 422A, 422B on the sides of the wheel hub 422C. Large diameter and narrow tires 422 are used. Air resistance due to these gaps may prove to be largest resistance in the entire vehicle.

FIG. 36 shows that inner wheel wells 422F are sealed so they hold a pocket of air. Maximum spacing of tires 422 apart across the body because they do not steer.

No mirrors or projections of any kind are used, which would increase aerodynamic drag significantly. Single volume of body no separate hood and cabin or trunk. Single volume makes air change direction less, thereby causing less pressure changes and air pockets.

The wheelbase is maximized. All three tires are same size. A slight distance needed between the rear of the ring 430 and the end of body. A distance needed between the front of the front wheels and the front surface so the front side of body can have the large radius.

The body is shaped with curves so that as the air moves over car body from front to back, at no time does it have to return faster than 15° anywhere on the body, in any plane to avoid separation. Air moves out of the way of the body.

FIG. 34 shows that air is required inside the vehicle for the batteries, powertrain, and cabin and air must be exhausted from these areas, as well. Air enters inlet 436 at a high pressure zone, which is located at the center of the nose. Air exits discharge 437 at a low pressure zone, which is at the rear, within the cut-off area of the Kam tail. Inlets and outlets needed are small for an energy-efficient car.

### Hybrid Power Train

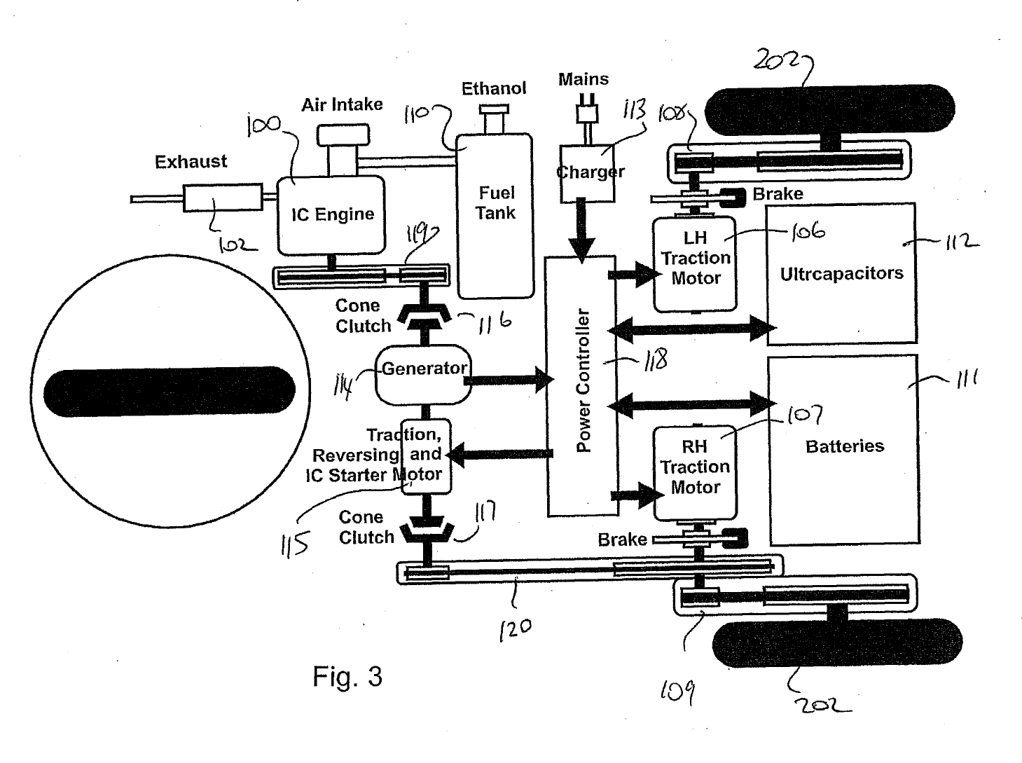

As shown in FIG. 3 the hybrid power train system focuses on a power generation system with relatively low overall horsepower (in the 20 hp range, at the tires). Also, that power is handled in the most efficient manner possible, minimizing energy losses, in order to maximize the possibility that the drive train is eventually fuelled by solely renewable energy.

As automobiles shrink in size and weight, and become more energy-conscious over the coming century, the hybrid design herein finds eventual application in city-cars. As the global car fleet mushrooms past a billion units well before century's end, it will likely be mandated to have a significant portion of new cars powered by renewable and clean energy. The hybrid drive, designed from the onset with this in mind, can make an important contribution to this end. The correct powertrain for a city-car, one specifically designed to run on a limited amount of sunlight, wind, hydro, and bio-fuels, can go a long way to averting technologically-induced, ecological catastrophes within these emerging nations.

The system is an electric/gas hybrid drivetrain. It is primarily an electric propulsion system with the inclusion of an internal combustion (IC) engine 100 with exhaust 102. This IC engine 100 strictly provides back-up, range extension, and high-speed capability.

The electric motors 106, 107 mounted in the arch under the seat bottom panel 371E drive the respective front wheels 202 through chain drives 108, 109. The motors are sized for acceleration and low-speed cruising, while the IC engine 100 and fuel tank 110 are sized for high speeds and long-distance driving. With cars, the ratio of energy needed for acceleration compared to that for cruising is in the range of 10:1, meaning that a dramatically smaller IC engine is needed under this hybrid arrangement which is somewhere around 10 times smaller than in a conventional IC drive.

Simply restated, the system is a conventional electric drive with a small IC engine added. In the engineering literature, this is a well understood hybrid arrangement. Technically the system is a series-parallel hybrid (for details, reference textbook ‘Modern Electric, Hybrid Electric, and Fuel Cell Vehicles—Fundamentals, Theory, and Design’, the disclosure of which is incorporated herein by reference). This arrangement eliminates the major disadvantages of electric vehicles, which include short overall range for the vehicle and long refueling times for the on-board energy storage. Typically a battery bank that needs charging overnight and cannot be charged quickly.

The hybrid drive improves on the pure electric drive in that it has virtually unlimited range and, when necessary, can be quickly refueled as an ordinary gas car. The hybrid arrangement improves on the conventional IC engine powered drivetrain in that it offers improved fuel efficiency, reduced emissions, and the capability to accomplish short trips in a cleaner and quieter manner, that is on electric power alone, without the need to ever start the IC engine during most trips. Therefore, the hybrid, like other similar hybrid systems, appears to provide the advantages of both the electric vehicle and the IC gas vehicle, without the disadvantages.

In the system, the electric motors 106, 107 are powered by a combination of batteries 111 and ultra-capacitors 112, meaning that this hybrid powertrain also has a hybrid, on-board, storage device. These two energy storage devices 111, 112 are electrically connected in parallel. The batteries store energy primarily from the mains (the electrical grid), making this a plug-in hybrid vehicle. The ultra-capacitors absorb energy primarily during regenerative braking and on downhill runs, and they release this energy during vehicle acceleration or hill-climbing. This arrangement is more energy-efficient under regeneration so that more energy can be recovered than when using just batteries. It is also less demanding on the batteries under acceleration and deceleration as the ultra-capacitors buffer the current seen by the batteries, making the batteries last significantly longer before needing replacement.

The IC engine 100 is a conventional 4-stroke, overhead valve, single cylinder unit. This can be thought of as a typical lawnmower engine, although its design would be quite a bit more sophisticated in the application of automotive technology for improved fuel efficiency and cleaner burning. This engine is fuelled by either gasoline, ethanol, or a combination of the two such as gasohol, E15, E85, etc. Its power requirements are largely steady-state which allows the design of the engine to be optimized. This allows maximizing the fuel efficiency and minimizing the harmful emissions produced by the engine, well beyond current automotive standard and well beyond the most sophisticated current production IC engine running on gasoline and undergoing transient therefore varying speed up and down.

Gasoline, of course, is a conventional fuel readily available today plentiful and relatively cheap. However, gas has major downfalls. This non-renewable resource will undoubtedly become harder to find and become more expensive to buy in the future. Upon burning within engines, it unavoidably releases its previously sequestered Carbon into the air, causing the greenhouse gas Carbon Dioxide to increase in the atmosphere which is an undesirable situation that could lead to disastrous consequences if this leads to climate disruption.

Ethanol has been around as an alternate fuel for automobiles ever since the car was invented. Ethanol is currently gaining some mainstream popularity primarily because it is totally renewable and because it typically produces less harmful pollutants than gasoline (it burns cleaner). Ethanol is also Carbon-neutral. Upon burning, the Carbon released into the atmosphere is the very Carbon initially absorbed from the atmosphere when the ethanol fuel-crop grew from seeds into plants. Therefore, burning ethanol does not add overall to the greenhouse gases in the atmosphere. However, ethanol also has some downfalls. To make ethanol requires productive farmland and this requirement can easily intrude on human food production. Ethanol production also has low net energy gain under conventional agricultural practices. Some studies even show a net energy loss, whereby it takes more energy to make the ethanol than you get out when burning it. In spite of these current disadvantages, and because of its advantages over gasoline, running the IC engine on pure ethanol is viewed as the most desirable solution for the future. But, this holds true only if the total quantity of ethanol needed by society can be minimized so as not to affect food production and if its net energy gain during the making of ethanol can be improved through modified growing and production practices, where energy inputs are minimized.

In short, if a vehicle can accomplish most of its travel using electricity from the mains and if the IC engine, when needed, operates extremely fuel-efficiently, then ethanol requirements become minimal and likely practical to produce on a mass scale. The societal issue will then become to manufacture this ethanol energy-efficiently and to produce the required grid electricity in a renewable and clean manner utilizing hydro, wind, solar, etc. Both are seen as doable, but only if overall energy requirements of the vehicle are absolutely minimized. Therefore, the drive system must be ultra-energy efficient.

To attain ultra-efficiency, two approaches are fundamental:

minimizing the power requirements of the vehicle itself so that the power needed at the tire to road interface is as low as possible

minimizing losses throughout the energy transfers that occur as electricity and liquid fuel are transformed into vehicle motion.

The above two approaches are related, but the system is primarily concerned with optimizing the powertrain within the vehicle. Optimizing the overall vehicle includes approaches such as more task-specific design, reducing unnecessary capacity and excess, improving air and rolling resistance, and reducing overall vehicle weight. In the future, as vehicles are designed more efficiently, then the power needed to drive them becomes significantly lower and potentially within the range of the powertrain we are developing. This will only broaden the current range of applications for the drive system we are developing here.

In regards to details, the low-horsepower, ultra-efficient, hybrid drive contains the following ten major components. Approximate values for each are provided in order to reinforce the scale of this hybrid drive, but realize that these specifications may vary slightly with further development:

Two electric traction motors 106, 107, series-wound, permanent magnet, 36 volts DC, 4 continuous horsepower each, 8 peak horsepower each (this means that for the complete vehicle there is available 8 continuous hp and 16 peak hp under electric traction).

Battery bank 111, sealed lead-acid, quantity 6 of 6-volt batteries connected in series for 36 volt system, total battery bank capacity of 10 hp-hour at 20-hour rate and 6 hp-hour at the 2-hour rate, total wet weight of 400 pounds, life expectancy of 10 years or 1300 deep-draw cycles.

Ultra-capacitor Module 112, 36 volts DC, Capacitance of 145 farads, specific energy of 35 Wh or 0.05 hp-hour, specific power of 2900 W or 4 hp, total weight of 35 pounds, volume of 0.8 cubic feet, maximum current of 600 amps.

On-board battery charger 113, 36-volt DC nominal 42 volt DC charging, powered by mains of 110 volt AC and 15-amp service, typical charging time 6 hours for depleted battery bank, extra-long electrical cord for charger has auto-retracting reel built-in for convenience in plugging in vehicle.

Alternator 114, 42-volt, to charge battery bank via IC engine and also utilized during regenerative braking.

Electric starter motor 115 for IC engine 100, which is a series-wound, permanent magnet, 36 volts DC, 1 horsepower continuous, also utilized for steady-state cruising on pure electric. This is more energy-efficient than steady-state cruising on electric traction motors.

Internal Combustion Engine 100 which is a 4-stroke, overhead-valve, single cylinder, 250 cc, air-cooled, producing around 5 hp at 3500 rpm when optimized for fuel efficiency and emissions reduction, 30 pounds dry weight, uses approx. 0.2 Imperial Gallons per hour from an 8 Imperial gallon fuel tank, catalytic converter and electric pre-heating before starting to minimize warm-up emissions, optimally this IC engine is designed to run on pure ethanol, but can also be designed to run on gasoline or any mixture of gasoline and ethanol or gasohol with minimal modification although resulting in increased harmful emissions.

Two Cone Clutches 116 and 117, pneumatically operated by electrically produced air pressure, used to engage IC engine to alternator 114, starter motor 115, or vehicle wheels 202 for highway cruising, also used to engage alternator 114 during regenerative braking, and engage starter motor 115 to vehicle wheels during electric cruising.

Electronic controller 118, centrally and singularly located which is the control of the system, gathering and feeding information through a minimum of hard wiring external to the box, includes all electric motor speed controls, clutch controls, charging and current limiting functions, IC engine controls, etc.

Chain drives 108, 109, 119 and 120 are used within the system, these include: from the traction motors to the wheels 108, 109 (approx. 4.5:1 reduction), drive 120 from one driven wheel to the first cone clutch 117 (1:2 speed increaser), and drive 119 from the second cone clutch 116 to the IC engine (2:1 speed reduction). All chain drives are highly energy efficient (in the order of 96 to 98%), are sealed in oil and virtually maintenance-free. The above components describe the basic drive.

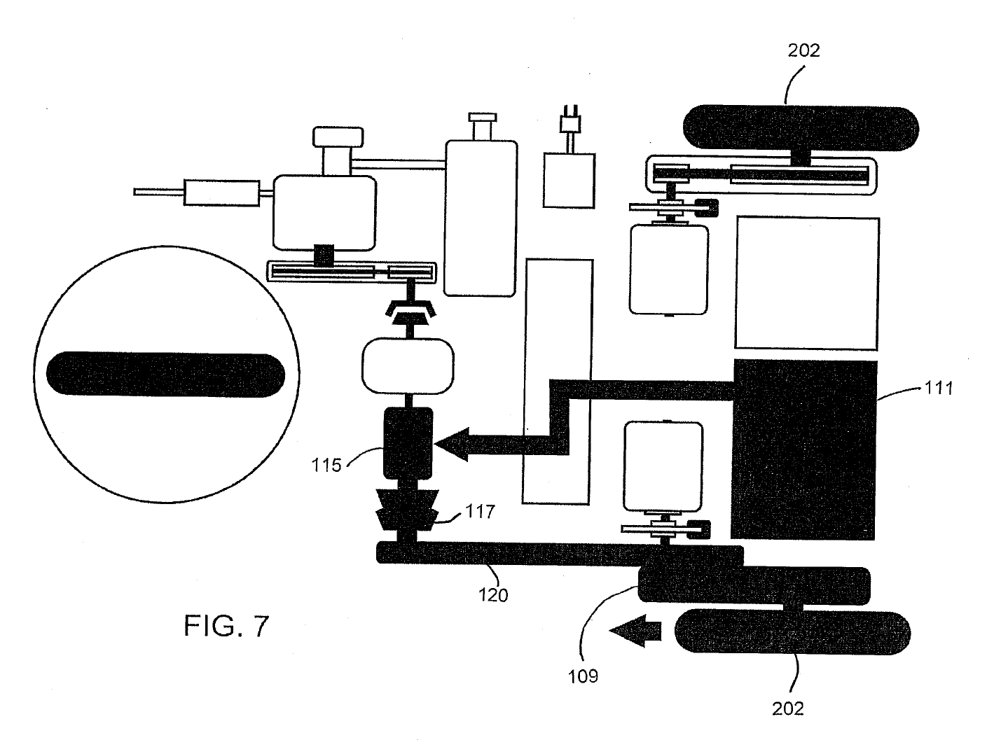

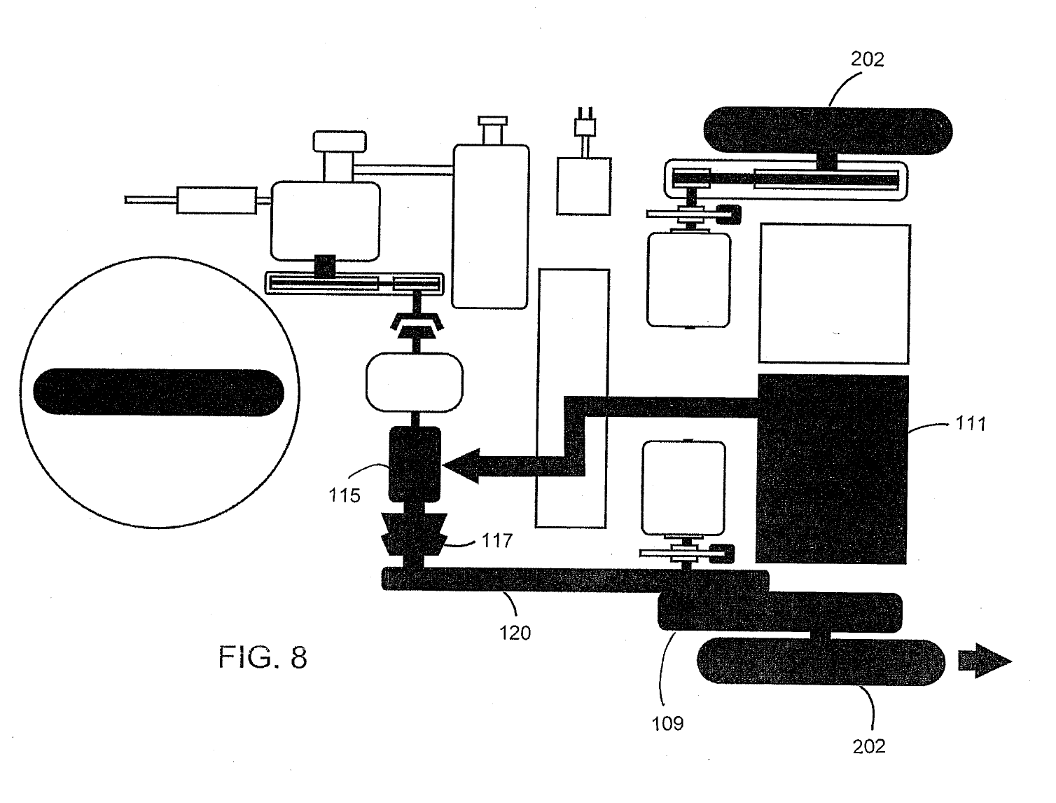

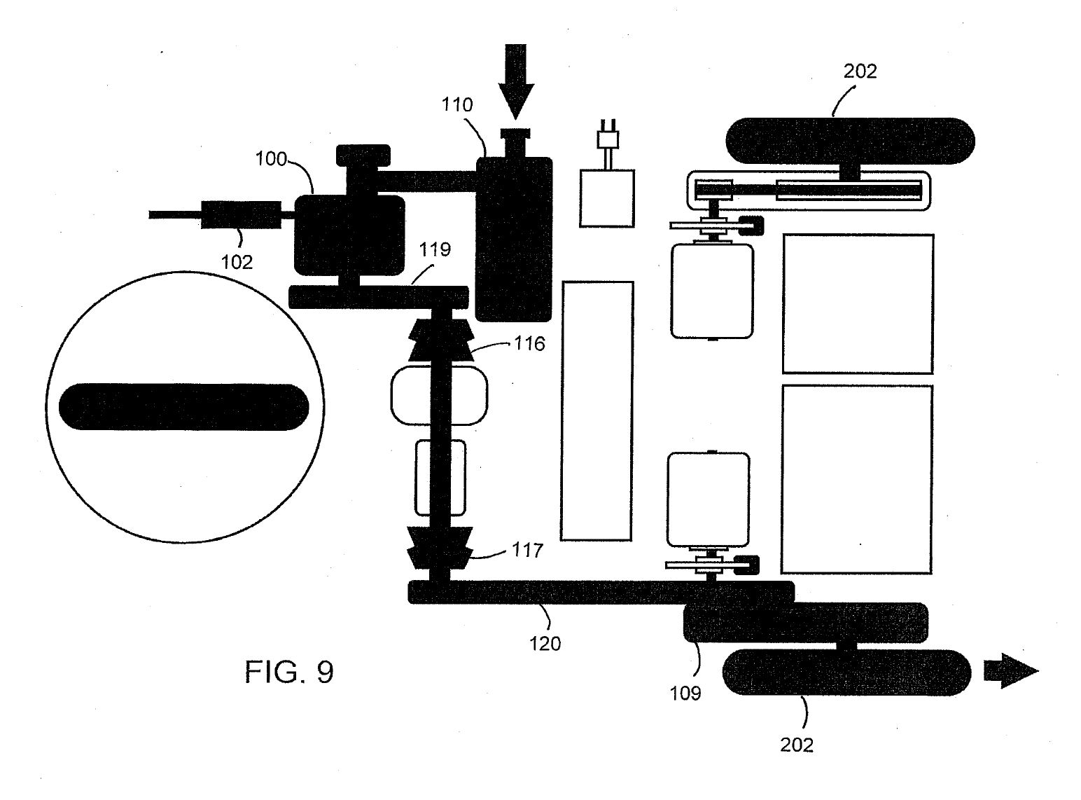

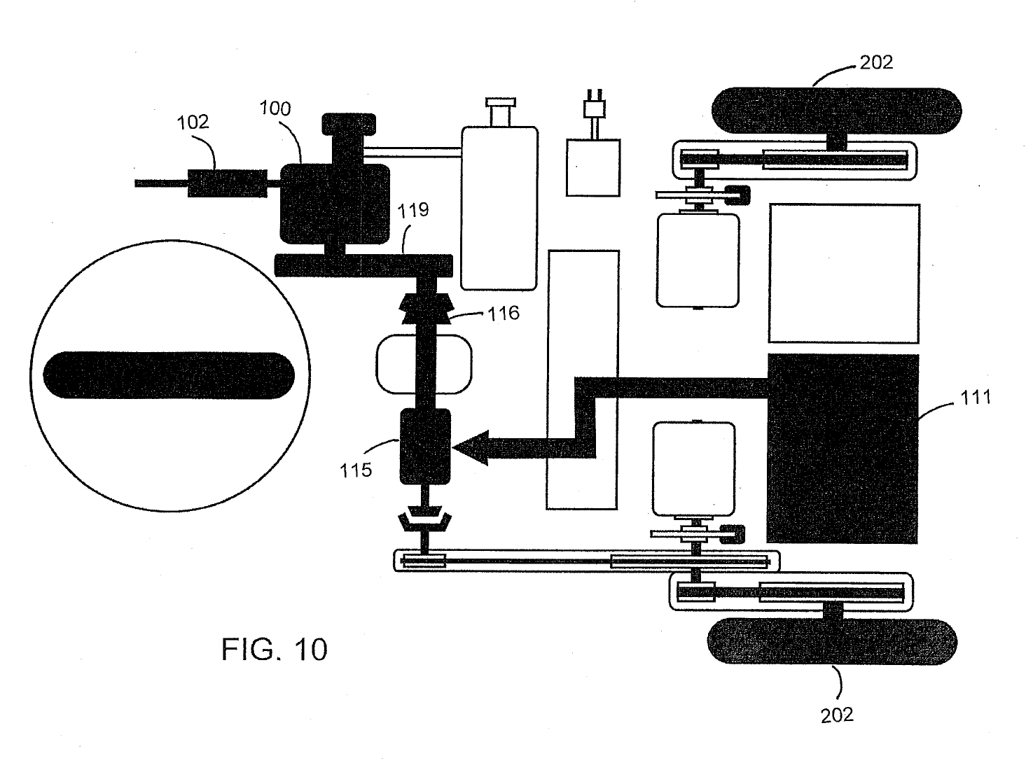

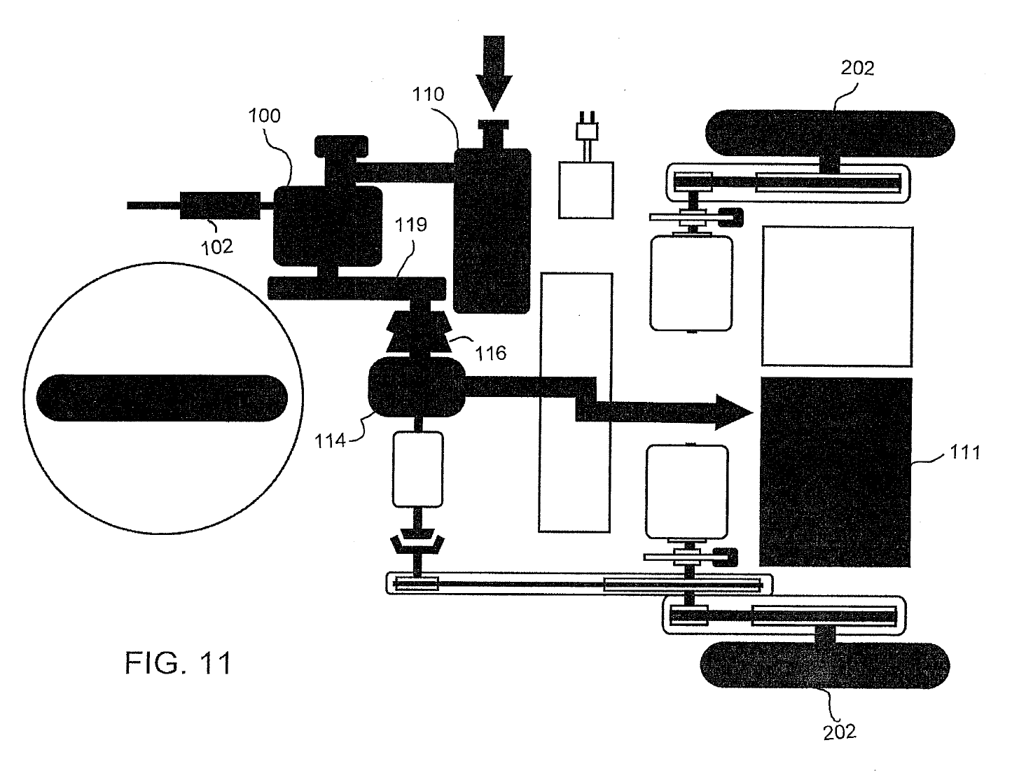

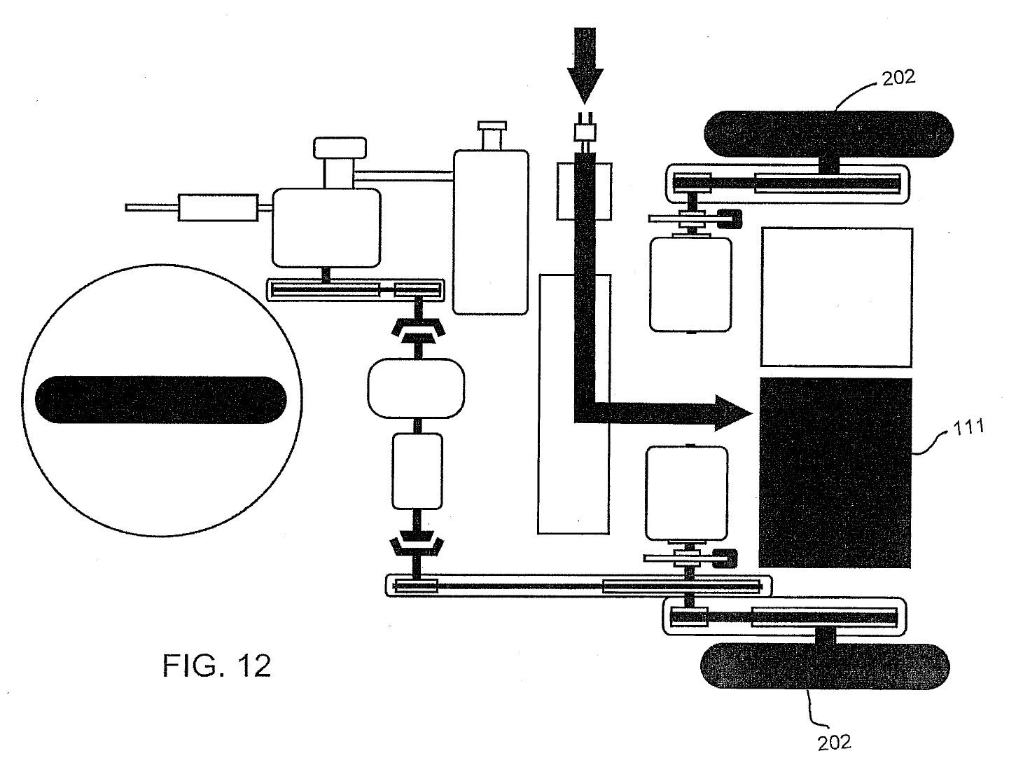

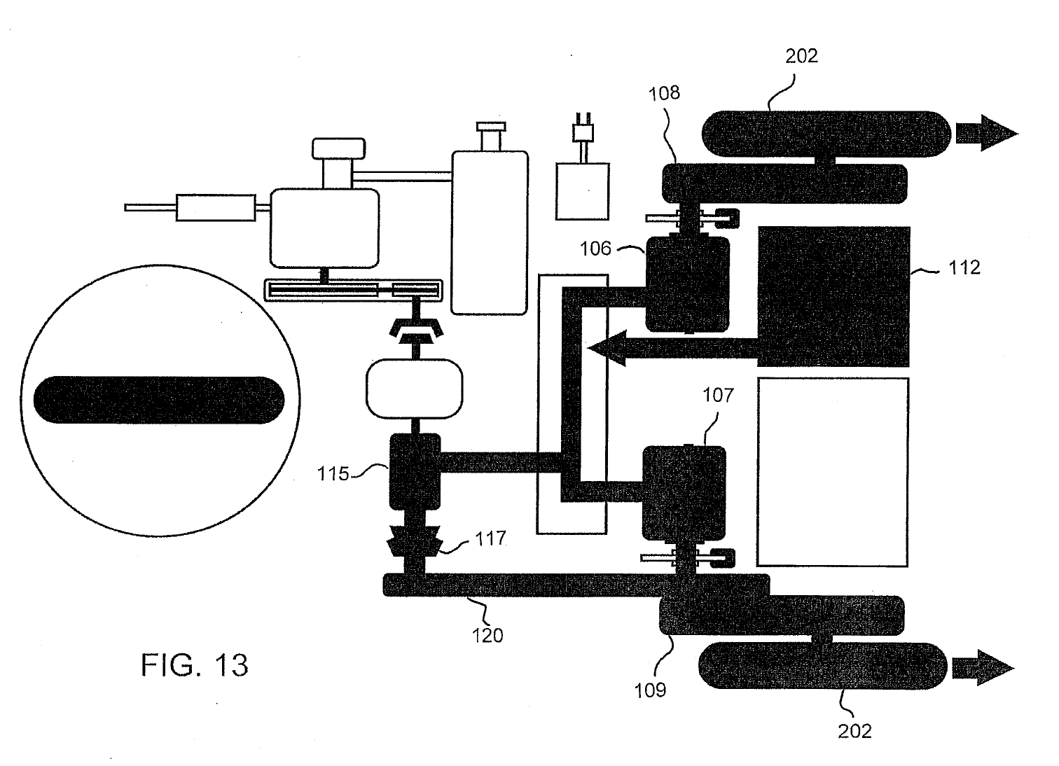

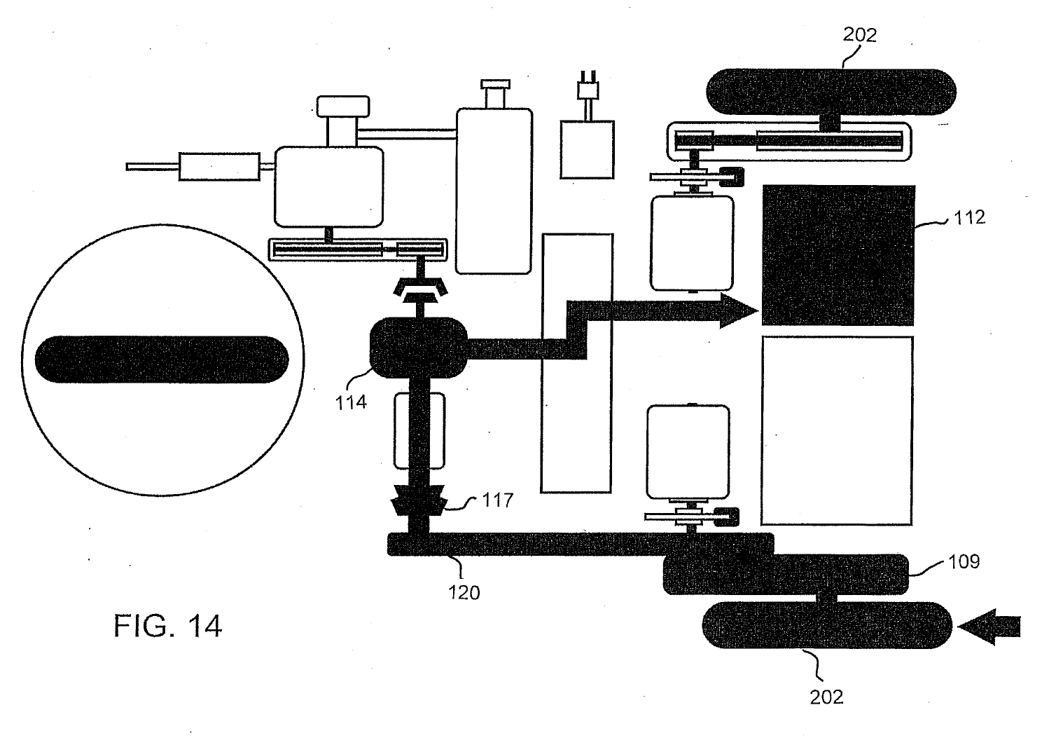

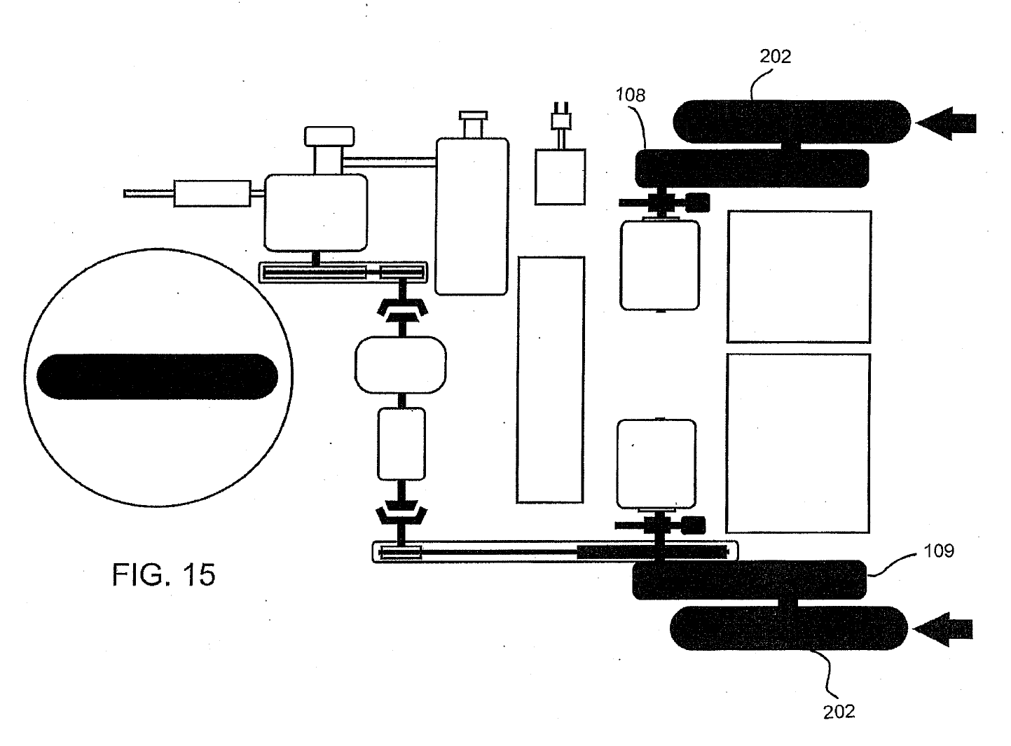

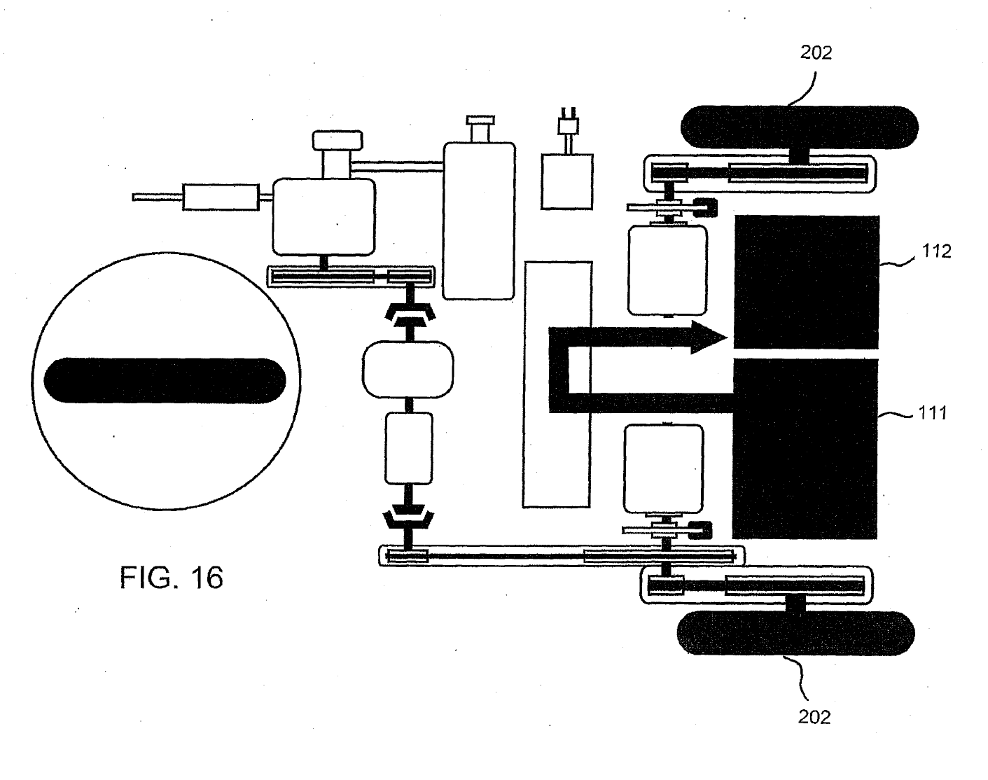

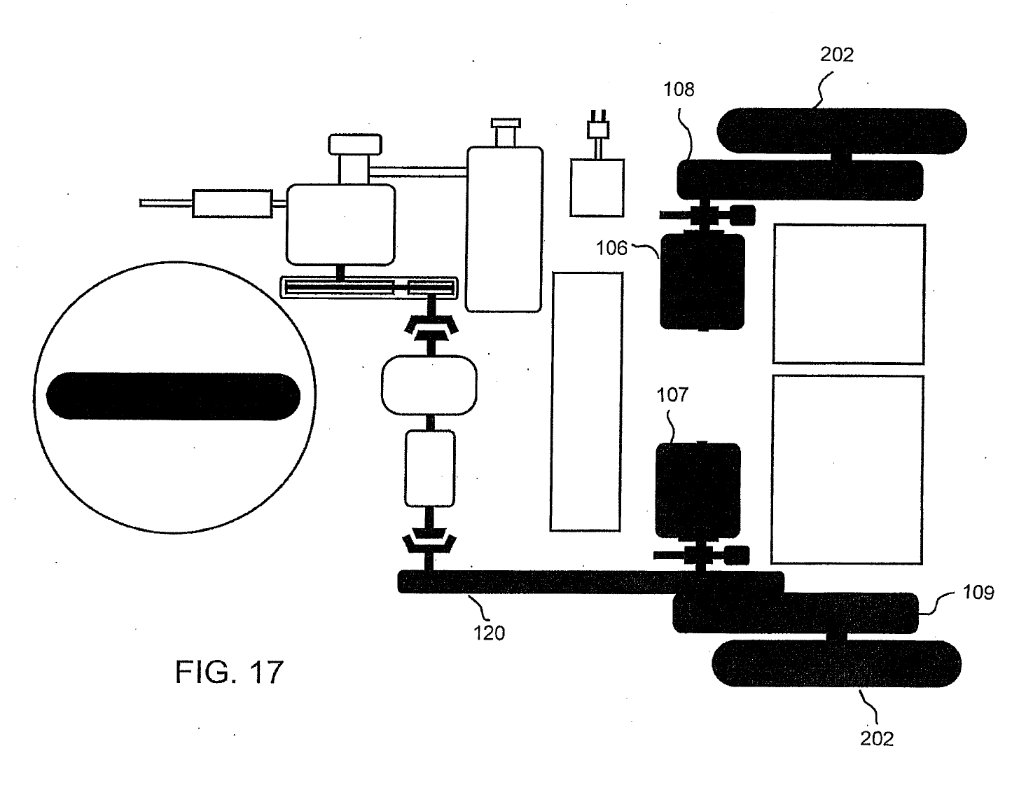

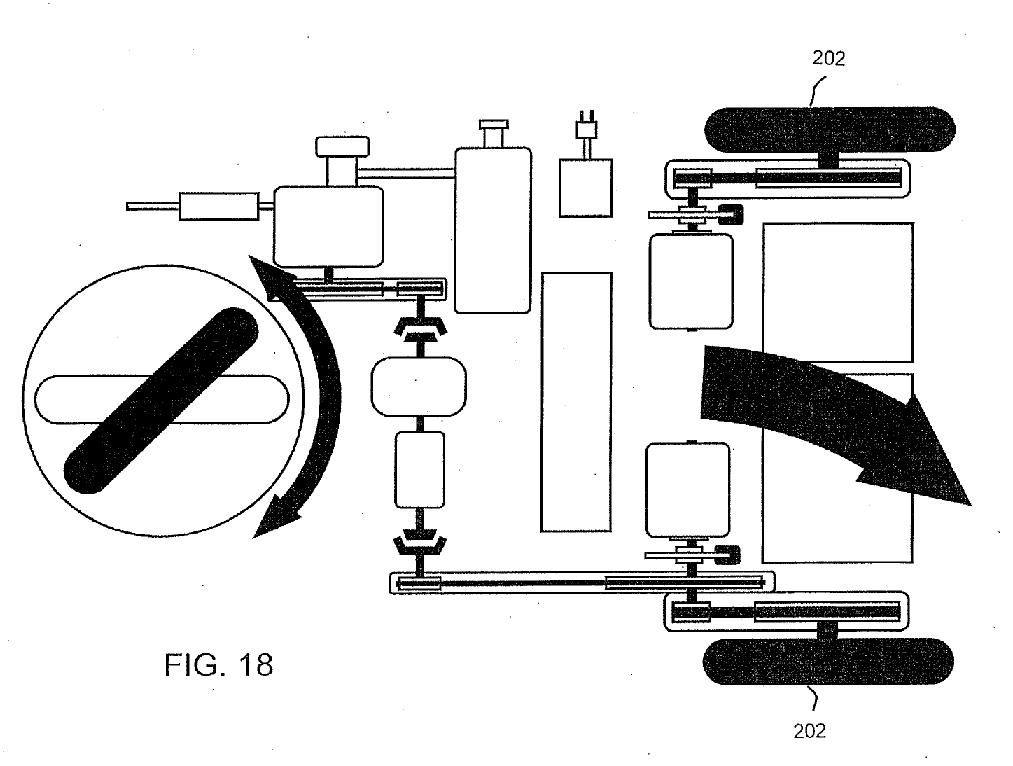

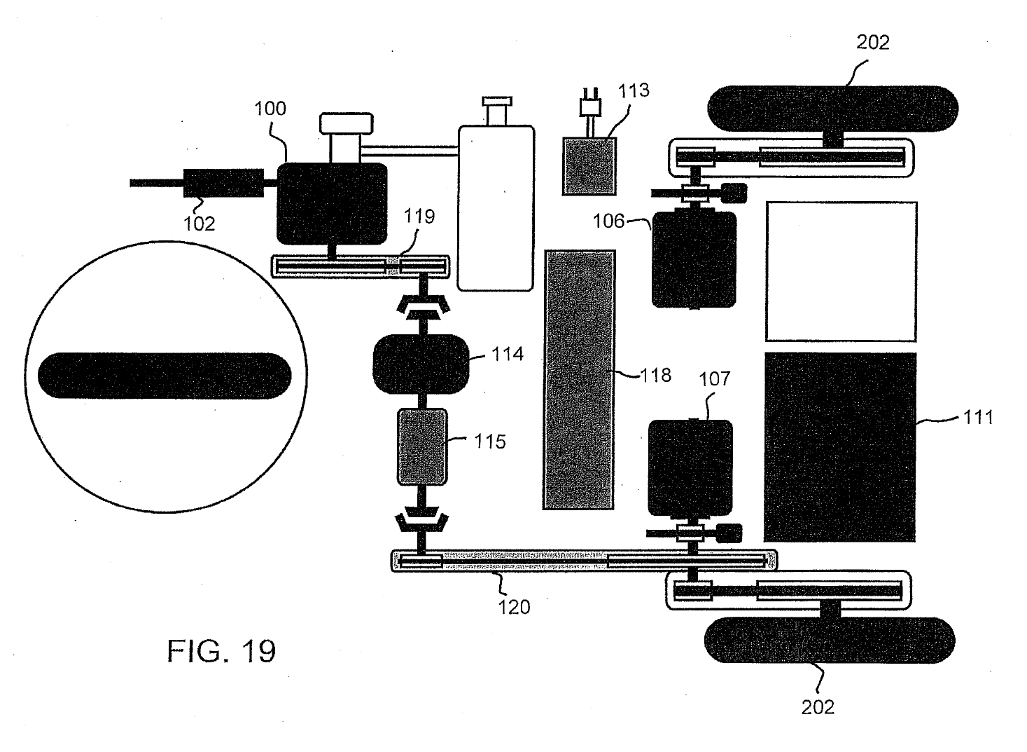

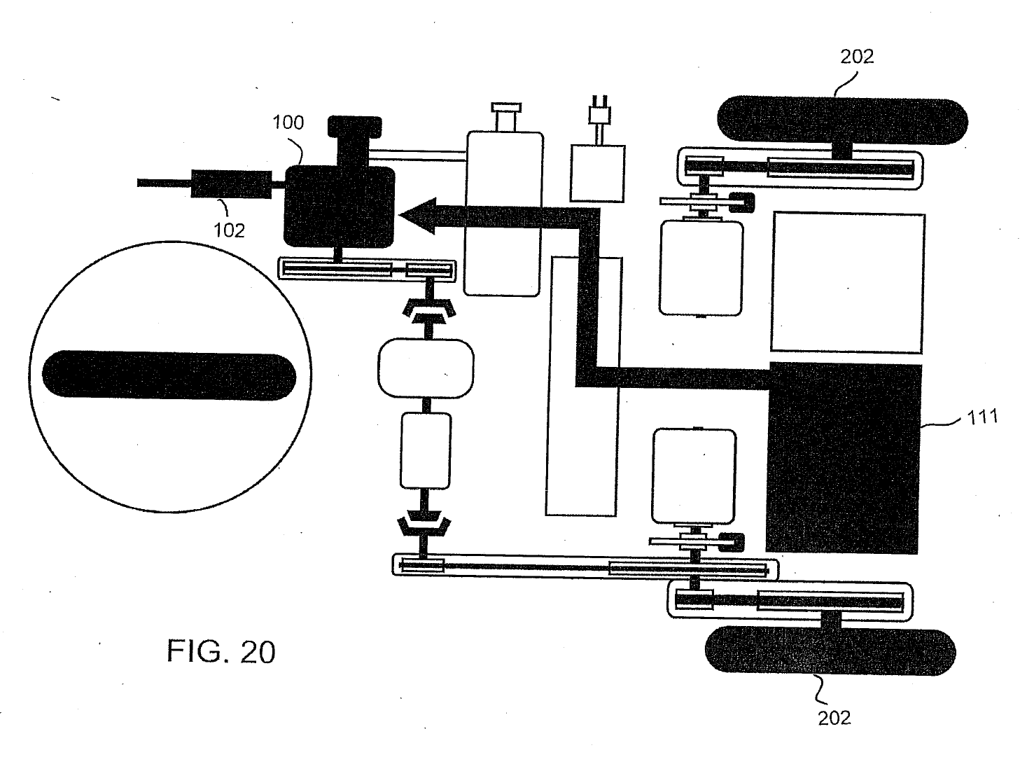

FIGS. 7 through 20 show various conditions of the system described above where the black arrows indicate energy transfers within the powertrain, all being managed by a central controller.

In general, the hybrid drive uses existing technology in a novel way (a unique choice of reasonably standard components arranged in a different manner).

In developing this drive, strict attention has importantly been paid to energy paths within the drivetrain and minimized all energy losses as much as technically and economically feasible. All losses turn hard-fought and expensive energy capture and employment into wasteful heat, not into vehicle movement. All heat eventually leaks into the air and beyond the atmosphere into Outer Space, never to be used by mankind again. Heat is the tell-tale of inefficiency. Heat is degraded energy, lost forever to the Universe. To avoid energy losses, only those established technologies best suited for the precise job at hand are employed, and the optimal requirements for each technology are strictly adhered to in order to maximize energy transfer. For example, an IC engine is best suited for operating at near its maximum load, at steady speed, and to be run for some time once warmed up. This is precisely its requirements in a series-parallel hybrid such as within the system. As another example, staying well within the abilities of economical and proven lead-acid batteries by hybridization of the energy storage with ultra-capacitors which allows for reliable and long battery life.

Aside from all the many detail design choices made for many good reasons, ultimately the advantages of the hybrid system over a pure gas or electric powertrain can be summarized by its performance and economy. The system is advantageous for primarily the following reasons:

Vehicle is able to run on electricity, when needed, with a range in the order of 30 miles on lead-acid batteries, increasing to 90 miles with the equivalent weight of Lithium-Ion as on-board batteries. This usefully accommodates most trips while only under electric power with no IC engine running.

Provides virtually unlimited range in city or highway driving when using IC engine constantly running IC engine in typical city driving charges batteries as quickly as they are depleted; under highway operation the IC engine operates as in a typical gas car, although in the system the engine is closer to optimum operating conditions than in a typical gas car.

Prior to starting IC engine, the system is able to pre-warm the engine using the on-board electrical energy storage source that is the batteries, thereby eliminating greatest source of pollution which typically occurs within first few minutes of cold running an IC engine. Since the IC engine is not needed at the start of trip the car can move as an electric while IC engine undergoes pre-warming. This will not prove inconvenient so that no waiting is required. Pre-warming the IC engine and catalytic converter is a known strategy to reduce emissions, but becomes highly practical in the system with its large on-board battery and its tiny IC engine. This provides lots of energy to warm a small package. The opposite is true on a typical modern gas car, which has a small battery and big engine. Pre-warming also makes running on pure ethanol practical in extreme cold weather which in winter cold, is harder to ignite than gasoline.

The IC engine runs at optimum state for most fuel efficient and least emissions, runs steadily that is non-transient, and runs for long periods at a time; these all being optimum for an IC engine application the IC engine is as small and light as possible while maintaining optimum internal surface area to chamber volume ratio. The single cylinder engine is 250 cc, which at most fuel efficient and cleanest burning rpm will produce between 5 and 7 horsepower. Therefore this IC engine is carried in vehicle as a reserve power source, not as the primary power source. The advantage being that many trips can be made as a pure electric vehicle which is the cleanest mode of travel, especially when the electricity is generated by renewable means.

The IC engine in the system is the least complicated imaginable relative to its achievements in fuel efficiency and cleanliness with a single piston, 2 overhead valves, and 4-stroke with basic fuel injection. This simple engine should prove more reliable and more economic in a vehicle than would a multi-cylinder engine optimized for transient behaviour through integration of magnitudes more technological complexity such as direct fuel injection, electric valve timing, variable compression ratio, and the like.

The hybrid energy storage system of batteries and ultra-capacitors allows the batteries to see far less current draw, in and out, which makes them last years longer therefore requiring replacement every ten years or longer.

The system, as can many hybrids, recovers a portion of braking energy through regenerative braking. The system will recover a larger portion of this energy as it has optimized this energy path and has employed ultra-capacitors which are better suited to absorb large doses of energy in a short period of time, as when braking.

In summary, the following benefits are provided:

efficiently turns on-board electrical energy into movement;

efficiently recovers movement energy and transforms a significant portion of this to on-board storage again to be used yet again under acceleration;

fuel-efficient when the gas engine is running under highway conditions optimized at turning fuel into distance covered at highway speeds;

clean burning when gas engine is running minimizing emissions;

simplest design of hybrid imagined to date which is the least complex hybrid;

reliable and long-lasting by nature of its design.

All designs are, in the end, a compromise. Proponents of emerging technologies tend to inadvertently ignore the near-infinite trade-offs necessitated by design. Claims for a design can easily be overstated and the downsides of the design never highlighted. This can too easily lead to the ultimate failure of the product in the marketplace. Therefore, the negatives of the hybrid are clearly understood and stated to be as follows:

The hybrid powertrain is physically larger and heavier than either the pure gas or electric system it replaces. Anticipated to be by about 20% to 30% greater, this is assumed to be manageable within the vehicle.

The hybrid is also likely more complicated than the pure gas or electric system it replaces even though the system is a relatively simple hybrid.

The hybrid, in light of all of the above, is likely more expensive than the pure electric or gas system it replaces, perhaps by a similar ratio to size or weight.

Although the cleanliness of the IC engine is constant, its fuel efficiency varies dependent on which mode of travel. It is most fuel efficient for turning fuel into distance at highway speeds. It is least fuel efficient when used to charge on-board batteries, a result of inescapable losses as fuel is transformed into electricity and then into vehicle movement. This is why IC engine should be used as back-up only for city travel.

It is felt, at this time during the development program, that the advantages of overall improved fuel efficiency and overall greater cleanliness outweigh these disadvantages. Highlighting these disadvantages from the onset alerts the developers of the hybrid and as much as technically feasible, to minimize size, weight, complexity, and production costs.

Applications for the hybrid drive exist in current production vehicles. Some of these would be transformed from either gas or electric versions into hybrid power trains. They include: people-carriers at parks, zoos, theme parks, and other events; local mail service vehicles; vehicles specifically used by the Police to administer parking tickets; neighbourhood electric vehicles (NEVs); golf carts; all-terrain utility vehicles.

When a longer view of the future is taken, one can visualize automotive applications for the hybrid drive. In particular, this pertains to the areas of the world marching towards modernity (such as China and India). Car populations in these areas of the world are on the cusp of experiencing exponential growth over the next century. The type of fuel that powers all of these new cars, and how efficiently these cars use that fuel, will become of strategic importance in avoiding environmental catastrophe when dealing with mushrooming car numbers.

The Society of Automotive Engineers (SAE), with its hundred-year history and 80,000 members located in over 100 countries, is the leading authority on anything to do with the car. At a recent Congressional meeting of SAE, former President Syed Shahed shared his insights regarding the direction car design should take in India.

According to Syed, India should be careful to not follow the “mindless growth” that has occurred in the United States, filling the streets with larger cars and larger engines that demand more gasoline and can ultimately cause ecological disaster down the road.

Instead, Syed suggests that the focus in India should be on sustainable technologies that will help the country grow its automotive industry in a way that is environmentally beneficial not only for itself but for the world at large. He believes that with this focus, environmentally friendly technologies developed in India can be marketed to other nations.

It is important, Shahed continued, that the country's very road-transportation mix be taken into account when companies develop vehicles and vehicle technologies. Safety is especially at issue because bicycles and motorcycles make up a large percentage of the vehicle population. As well, there is heavy pedestrian traffic in this “urban mobility melange,” he said, so small urban cars are in order.

Only a few groups today are researching and developing such an environmental ‘urban’ car as pointed to by Syed Shahed. The present arrangement provides a researched city-car and ultra-efficient hybrid drive. Below are a few ecological prototypes recently created by the automotive industry, which points to the possible shape of things to come.

Designing a low horse power ultra-efficient hybrid drivetrain is technically very challenging. To attain real-world applications by replacing drive trains of existing ‘gas’ or ‘electric’ vehicles of similar power (in the 20 horsepower range), the hybrid drive must prove to be economical, light weight, and compact. Above all, to achieve these requirements, the hybrid drive must be simple in its design.

Outwardly simple designs that work well, are reliable, long-lasting, and sell to a global market, are never easy to achieve. But that is our goal with this drivetrain: to articulate possibly the simplest, most energy-efficient, and least polluting hybrid drive visualized to date. One that can initially power hundreds of thousands of small utility vehicles and eventually power a significant portion of the global fleet of automobiles, likely over a billion by century's end, on predominantly renewable energy.

### Rear Wheel Steering

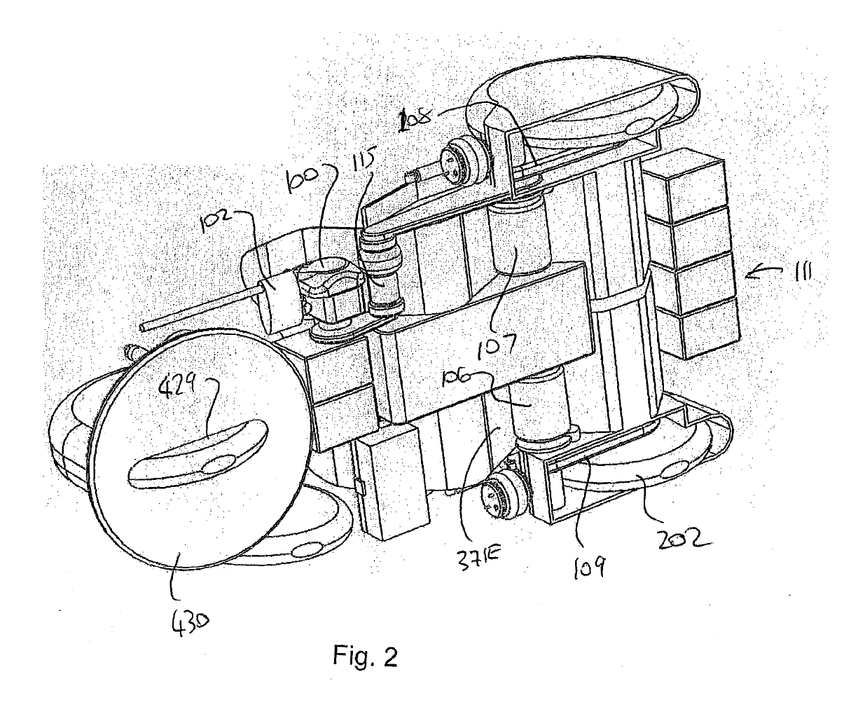

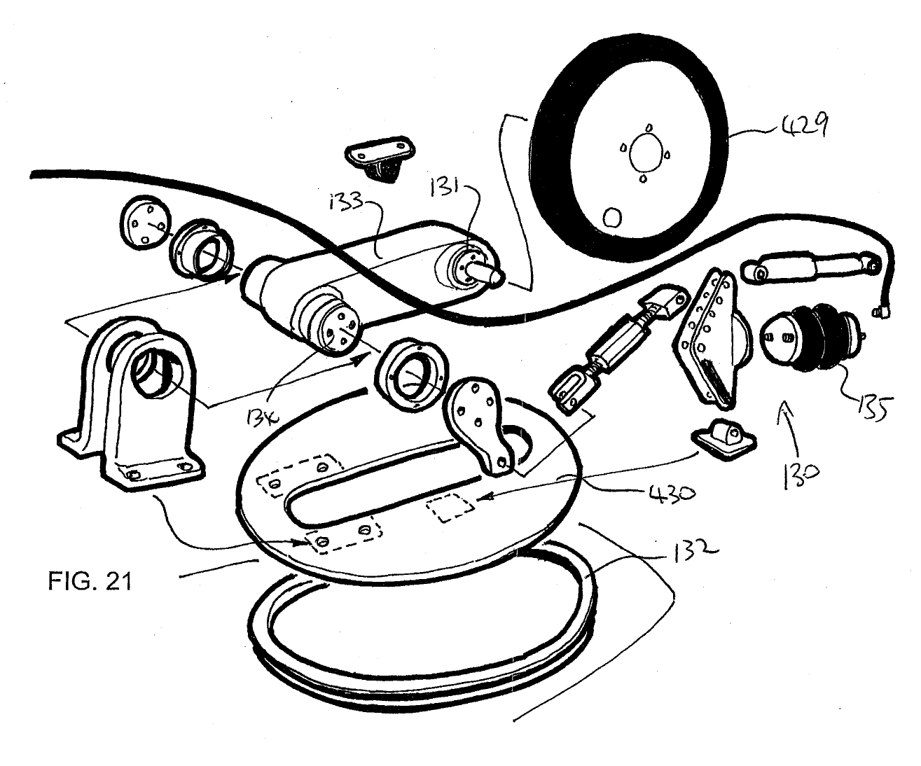

In FIGS. 2, 5, 6, 21 and 24 is shown the steering system which includes the main rear disk 430 in which the rear wheel 429 is mounted for up and down suspension movement on suspension 130 and on wheel bearings for rotation about its axis. The rear disk 430 presents a flat bottom surface carried in a ring bearing 132. The rear disk 430 is rotated about a generally upstanding axis by a cable pulled in the two directions by the vehicle steering wheel. The suspension 130 includes an suspension arm 133 pivotal on a mount 134 carried n the disk 430 resisted by a spring/shock absorber 135.

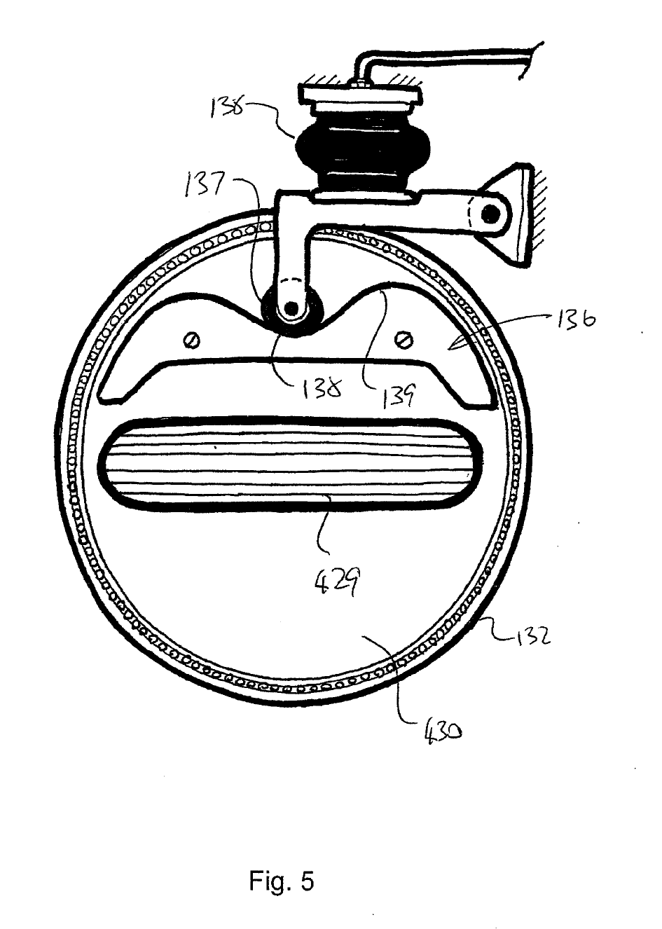

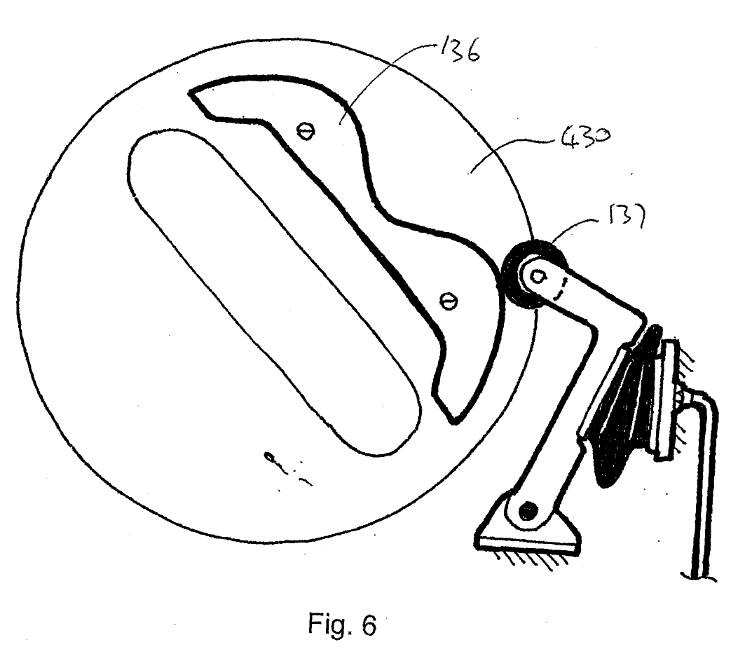

For the self centering shown in FIGS. 5 and 6, the disk 430 is centered by a cam 136 carried on the disk and rotated by a cam follower roller 137 carried on the vehicle body. The cam follower 137 is biased into engagement with the cam by an air spring 138. The cam 136 has a center position 138 and two lobes 139. When the steering wheel turns from left to right the follower 137 rolls up one of the lobes 139 so that the cam 136 pulls the rear wheel into the centered position 138. The bottom of the car and the ring 132 are angled up about 5 degrees so the rear wheel steering pivots on the ring 132 and the ring is tilted 5 degrees up at the back. In other arrangements (not shown) the wheel is centered on the axis to provide forward trail. In other words the tire contact patch was ahead of the pivot. Win this arrangement, the rear wheel is in the correct position to have neutral steering. The contact patch of the wheel is completely in line with the rear pivot defined by the ring 132.

Steering is controlled by the steering wheel, chain drive to the center of the car, there is a small drive fine that gets down to the floor of the car, pivoting the steering up and down to get you into the seat.

A mechanical spring can work for this invention, but applies a given force diagram on the cam at all times, regardless of vehicle speed. One should note that the self-centering is needed to stabilize the vehicle at speed, and is not needed at low speeds such as when parking or in parking lots. At these low speeds, there is no need for self-centering an in fact, the driver is fighting this feature. It would be much better to have it eliminated or minimized at these low speeds. So, with the air spring 138, this is possible by varying air pressure with vehicle speed.

At higher speeds, self-centering becomes more obvious and stabilizing for the vehicle, as the air spring is fed higher pressure. At lower speeds it becomes less so, as air pressure is bled off and reduced. Some safety features are incorporated to make sure self-centering has air pressure at speed, or it would alarm the driver although no loss of steering occurs, if this happens.

Electrical Wiring and Assembly within the Car

Car wiring used to be minimal in the old days. A few wires attaching a few components. Even as late 1968, after almost half a century of car development, the Chevy truck has very few wires and a minimal wiring harness. But, things have changed starting about in the 70s. Modern cars are now becoming more like rolling computers. Some cars nowadays have over 75 sensors and numerous ‘back boxes’ all over the car. Hybrids and electric cars are even more complex than the modern standard car regarding its wiring requirements. So, nowadays, the wiring in a car is important, incorporating hundreds and perhaps thousands of connections and wires.

Not much has changed in how this is put together. It typically is a wiring harness put in a loom with wires breaking out of the loom at the location a connection is made. This harness is snaked through the cavities of a car and hidden as much as possible. This system is efficient in that it uses the least wire and takes the optimum hidden path to each electronic device. This system, in other words, is the least cost option of electrically connecting components. As can be expected, troubleshooting this system can be, and is, problematic.

In designing a hybrid, first one must accept that the wiring is going to be a big part of the design. Typically, within mobile equipment such as tractors and buses (what I have experience in), wiring is left as an afterthought in the design (a leftover from the days when wiring was minimal). Second, one must simplify the electrical as much as possible. Minimize features and automation to the absolute minimum. Third, one must accept that electrical problems will occur, and that troubleshooting then becomes of paramount importance. When trouble occurs, one must have access to all the wiring at key junctions, in order to establish where the problem is isolated. Without this ready access, the mechanic/electrician is left guessing and ‘trying’ to fix it, instead of systematically identifying the problem and rectifying it directly.

Schools that teaches automotive mechanics use wooden bucks that have all the wiring of a car exposed (in order to teach automotive electrical systems). In the design of the present vehicle we first put all the car's wiring and components on a 4 foot×8 foot sheet of plywood, mounted vertically. We did this before we had a car to work on. This illustrated all the wiring that needed to go in the car in a very understandable manner. We used standard electrical bus bars to connect all wires and components, and labelled everything. We did not think these bus bars and this system would go into the car, it just helped organize the wiring. It was this wiring mounted on plywood, which was so easy to understand and troubleshoot, that suggested that this could be done in the vehicle itself

In order to lay out the electrical system within the vehicle in a similar manner, we needed to find enough flat areas within the car to spread out the wiring in an understandable manner.

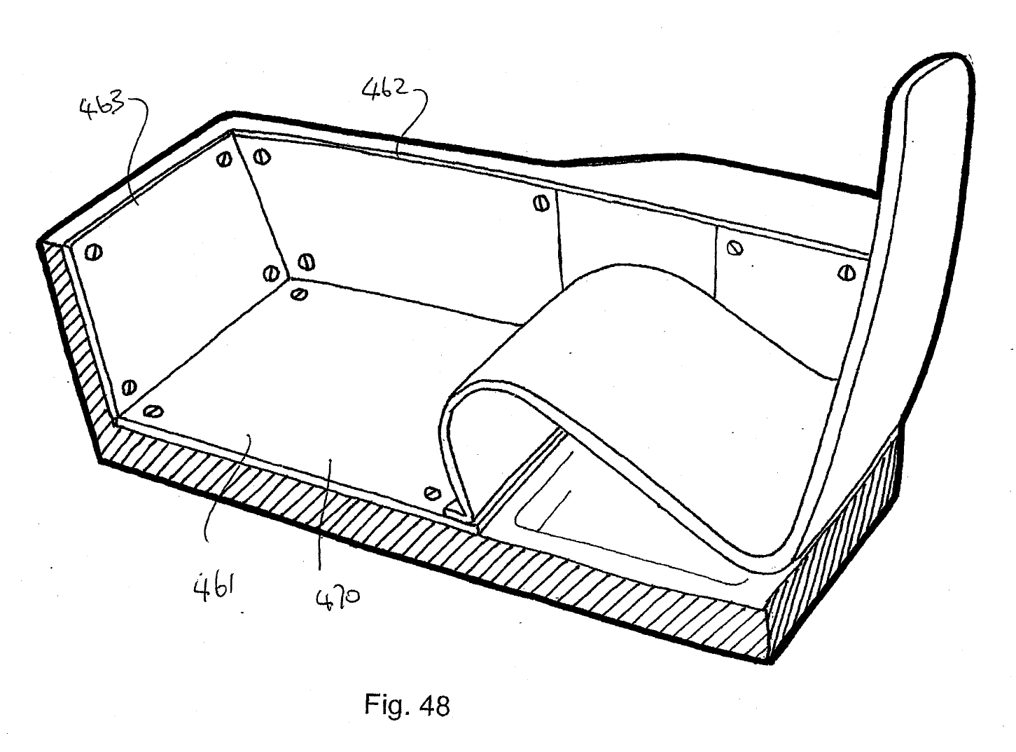

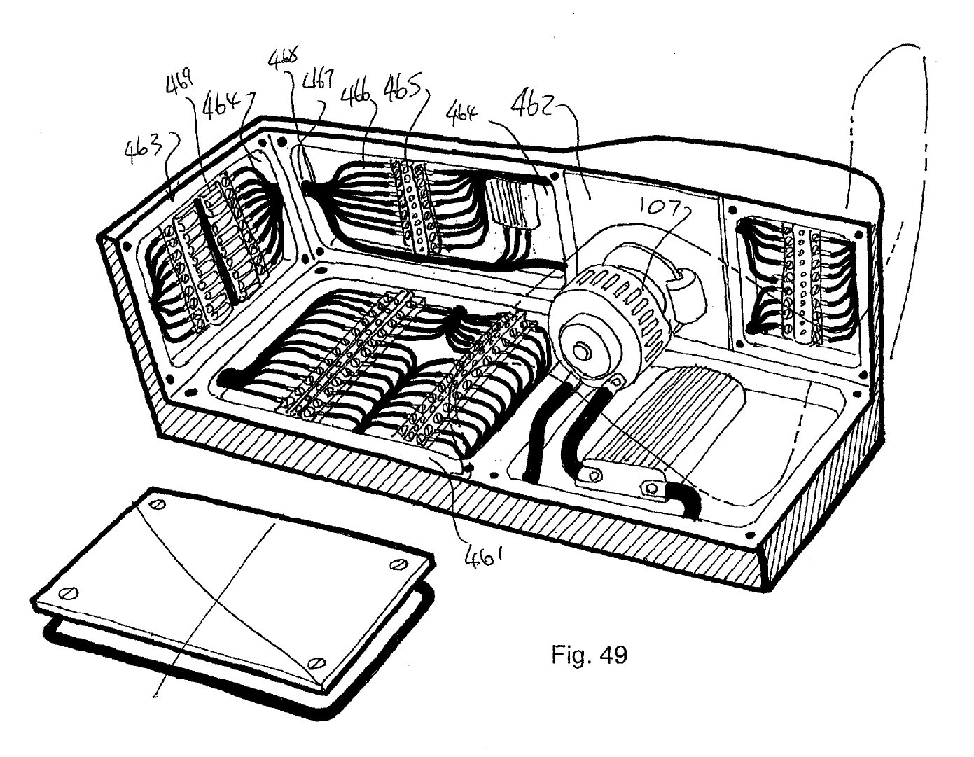

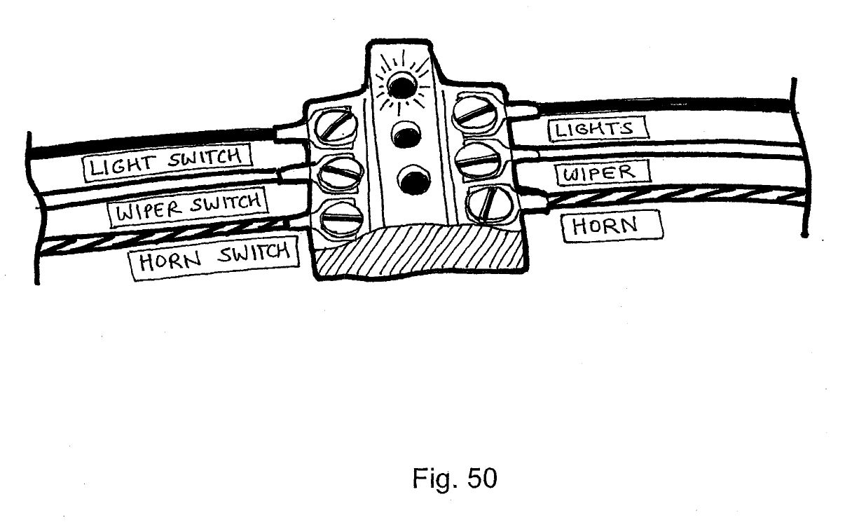

As shown in FIGS. 48 and 49, we found it in the car's floorboards 461, side vertical panels 462, and front vertical panels 463 and all over the vehicle in various places. Thus the arrangement herein is based on the concept of finding and designing these large surfaces and then making them into cavities 464 about 1 inch deep that can contain the bus bars 465 and wiring 466 and labels. Once you have large surfaces, connect them with cavities 467 that wiring harnesses 468 can fit through then spread out the harness within the cavities. Bus bars 465 are provided that allow electrical measurement at all critical junctions and allow quick disconnection of wires at these junctions to electrically isolate components. Labels 469 are provided within these cavities that describe the function of each junction. Also colour coding of wires is provided to aid in understanding. Fuse panels and other components and ‘black boxes’ can all be labeled clearly and organized in an understandable, logical manner. It should be noted that this will cost additional wire, and cost more than the traditional methods, but its benefit is when something goes wrong. Thus the invention in its ideal form, physically lays out the wiring of the car in a similar fashion to the 1-page wiring diagrams shown in old car manuals when they were just on one page, not in full chapters as they are now.

Important in the invention are these criteria:

1. enough flat space within designed-in cavities in the car that wiring can be spread out in an understandable manner (floorboards offer a large area, to start, but they can be found all over the car)

2. provide covers 470 that seal these cavities effectively (especially in floorboards) and yet are easily removable for troubleshooting including multiple screws or dzus-fasteners and large o-rings that fit in recesses.

3. standard or equivalent bus bars that allow junctions of wires that provide electrical access (measurement) and easy disconnection (electrical isolation), here wires use terminals and are attached with screws

4. within the bus bar or beside it, have enough room to provide an led light that shows that power exists at that junction

5. near bus bar junction, have enough flat space and room that an easily-read label can describe the function of that wire, or that an entire text/wiring scheme can be underlaid that describes all junctions

6. have enough room that wires and junctions can be laid out in a logical manner that best fits the mental model which is in the troubleshooter's mind ideally aiming at people with minimal technical prowess.

7. All electrical components (black-boxes, small electrical units, fuses, can all be handled within these cavities in a similar manner to the bus bars as shown in the drawings and therefore be fully labeled and easier to understand.

### Temperature Management

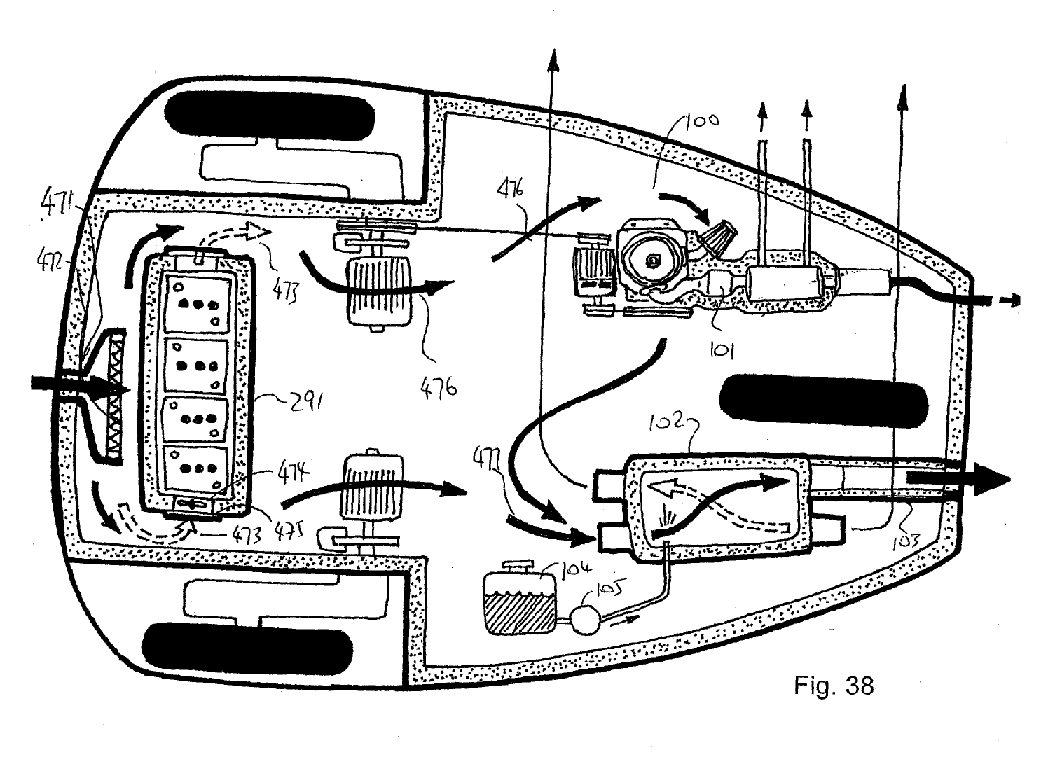

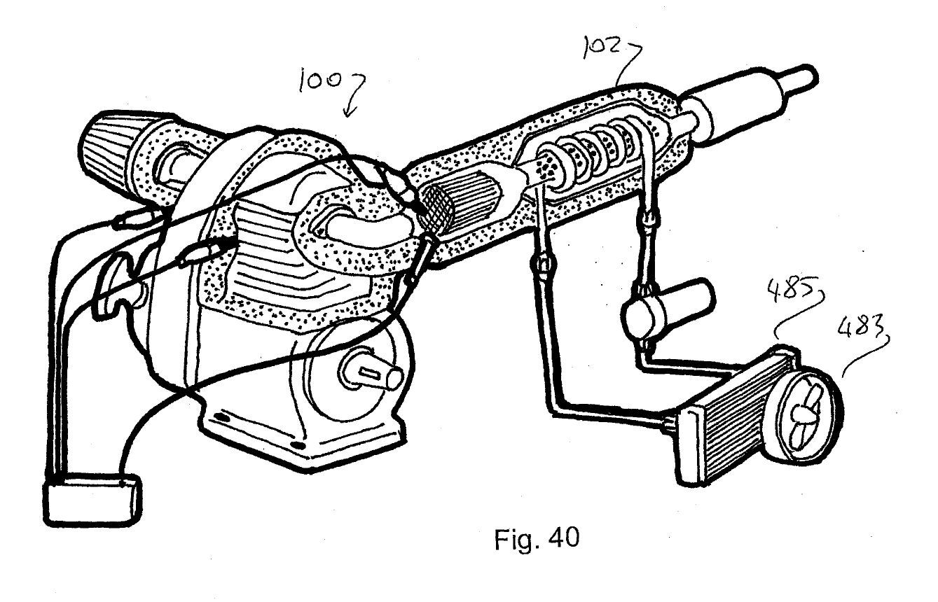

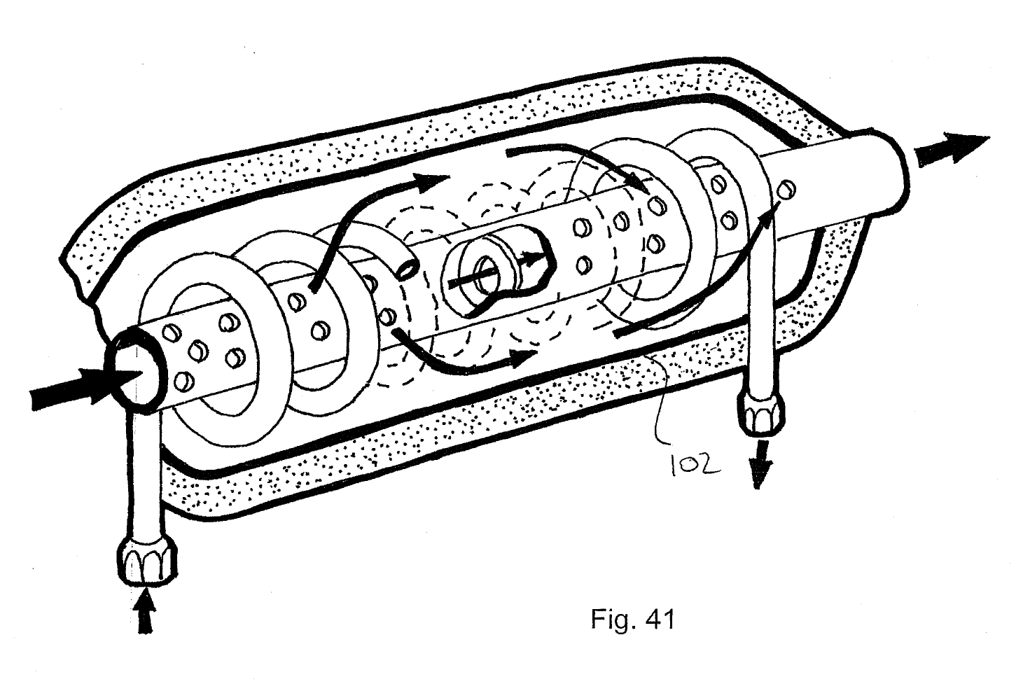

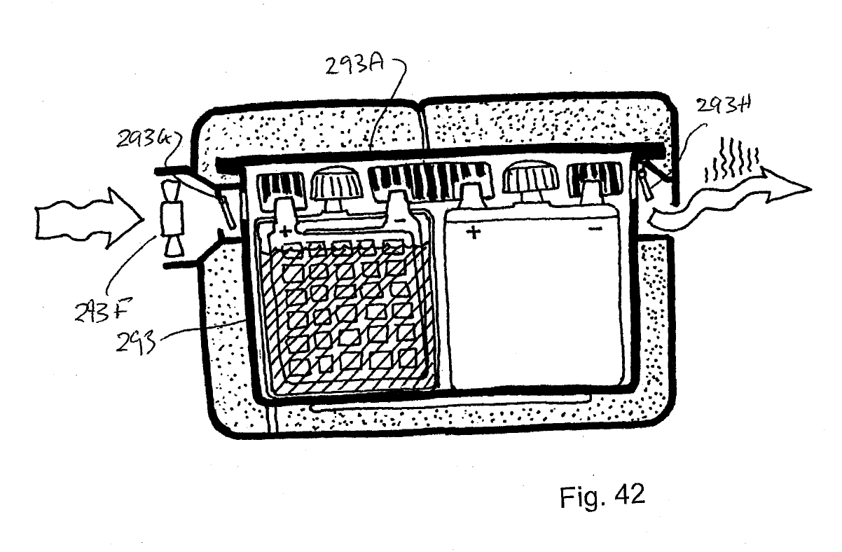

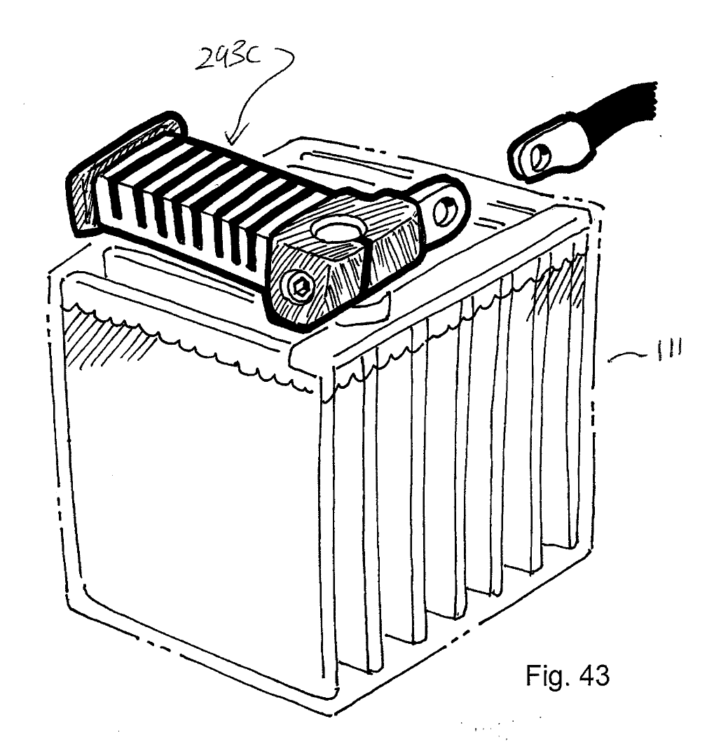

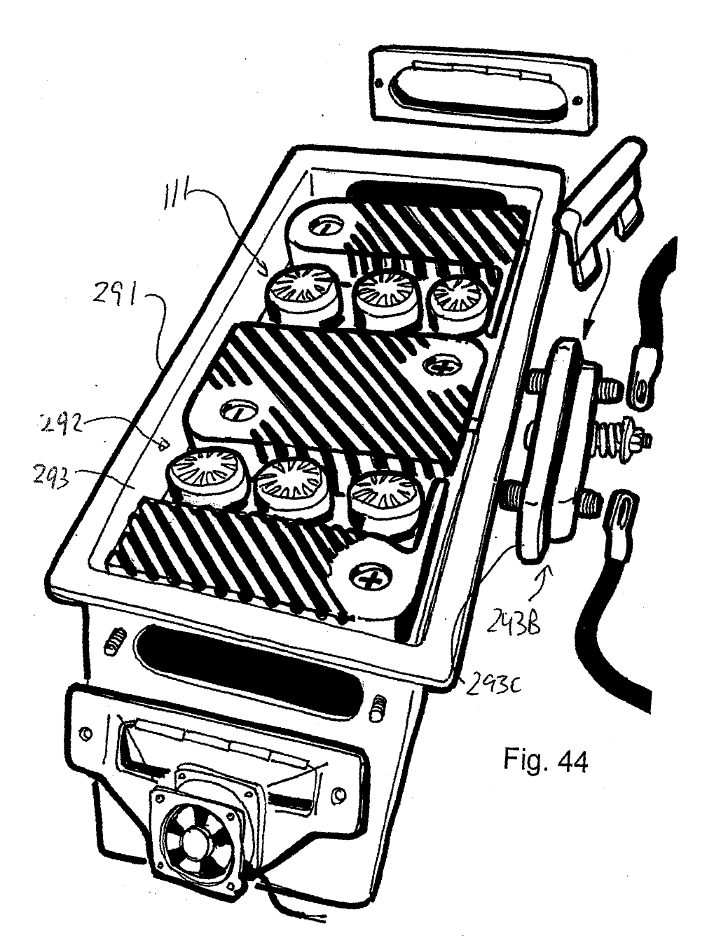

Turning now to FIGS. 38 to 44, the temperature management and emission control system is described.

Not enough attention has been paid, in the past, to maintaining proper battery temperature in electric vehicles. Specifically keeping them warm in the winter and keeping them cool in the summer. Lead-acid batteries operate best at room temperature.

In FIG. 44, the design is a stainless-steel, sheet metal box 293 that contains batteries 111 surrounded by insulation with no thermal breaks from inside to outside.

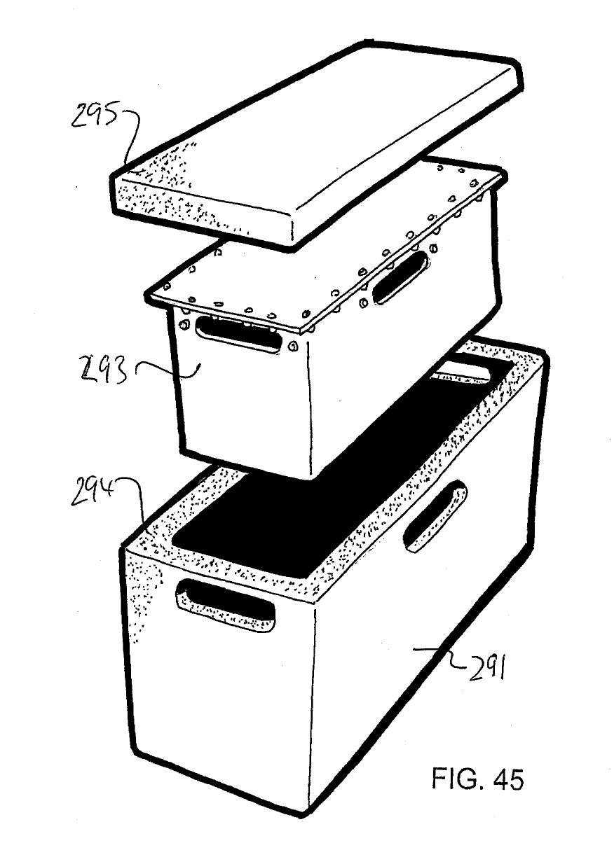

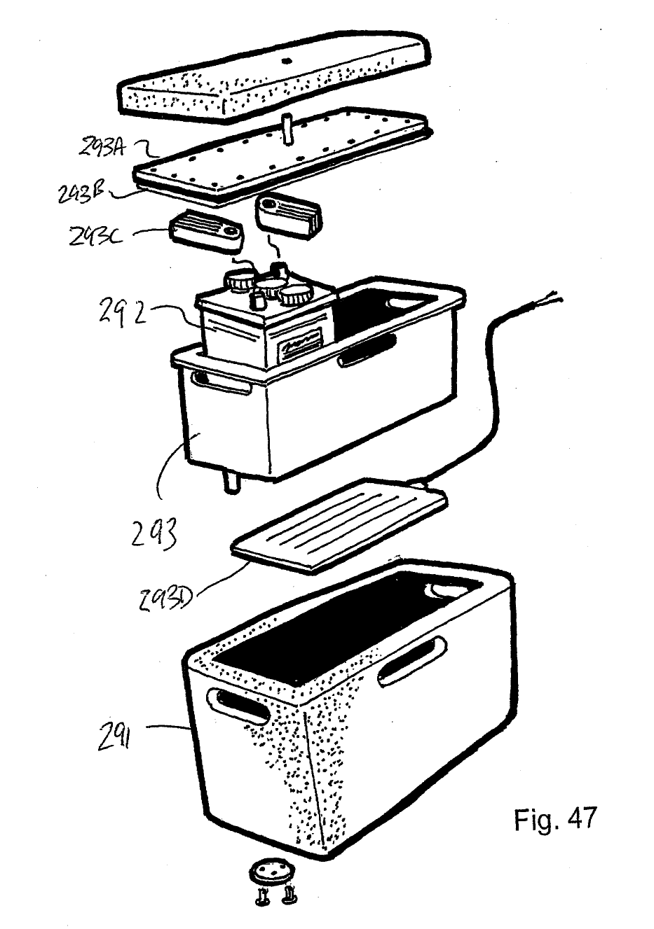

Sheet metal box 293 is perfectly smooth on inside and has bolt-on lid 293A that fully contains chemicals and/or explosions (or electrical fires) in case of collisions, shorts, etc. Slots in sides of the box allow passage of in/out cables 293B and in/out of cooling air. Typical thickness of insulation is 1½″ all around. The slots are covered with custom plates 293C. The stainless box has a vent for H₂ gas and openable drain for cleaning. Structural brackets surround the insulation and contain the stainless steel box, and do so without metal-to-metal contact. FIG. 45B shows a vent at top, open all the time with a tiny hose, to purge any hydrogen gas created. Items in FIG. 47 are from top down: Insulated cover 295 with vent pipe 298; Metal battery cover 293A of stainless steel with plastic sheet underlay 293B to prevent electrical shorts; Battery post cooling fins 293C; the Lead-acid battery 111; Stainless battery box 293 with drain 296; Battery box heater 293D similar to a waterbed heater, powered by either on-board batteries or wall plug; Insulated outer battery box 291; Drain cover 296. The two batteries are hooked up in series, just as an example, in the metal box. A cooling fan 293F is a very low-volume airflow fan, as not much heat is generated by the batteries over time since batteries heat up during discharge or charging due to inefficiencies, only about 80% of energy comes out or goes into batteries and 20% goes into heat. Movable flaps 293G and 293H allow air in or out. These flaps can be gravity-closed, or mechanically driven open or closed. Openings can be shielded from inside in order to minimize exit of acid or flames in case of accident. The battery pack is a unit connected to by two outside cables. An emergency disconnect is provided that is pulled out and detaches battery bank from car. This is not a fuse, but a mechanical disconnect built into the battery box. The battery post cooling fins 293C double as battery-post-connector-cables. Fins are angled to allow various battery orientations, while still allowing correct airflow. The positive and negative plates are in liquid. Heat generated in a battery occurs in the liquid and plates. With the body of the battery surrounded by insulation, the only way for this heat to be transferred efficiently is through the battery posts. Battery post cooling fins 293C transfer heat from the battery post into moving air. Insulated flaps 293G are closed when no cooling is required, and open when cooling is needed. Heated air from battery inefficiency is either used to heat cabin through use of heat exchanger, as described hereinafter, or is exhausted from car. If ambient air is cooler than the batteries, and batteries are too hot, then the fan is activated. Best achievable cooling temperature for batteries is ambient. If the batteries are too cool, and being heated by the element 293D under the battery box, the flaps are closed and the fan is off. The clamp and cooling fins are so designed specific to top of battery so that part must install at certain orientation, and can not rotate.

The vehicle is almost half glass (the top half), and half body (the lower half). The traditional design-way to handle high sun (no cloud) summer conditions is to size the air conditioner accordingly. The most energy efficient air conditioning unit we can find exceeds the on-board horsepower of the vehicle, so this is not an energy option. So we must have other strategies for keeping the car cool in these extreme summer conditions.

Some of these strategies are inventive and are listed here, as follows, and are in two groupings. The first group lets the heat into the car, and attempts to exhaust this heat as quickly as possible. The second group tries to stop the heat from entering the cabin in the first place.

### Group 1:

1. A small solar panel on the roof or inside the car (facing up) directly powers an interior fan that exhausts interior air. The fan runs when the sun shines. The best one can do is maintain ambient temperature within car, but with enough effective air movement, this would be quite an accomplishment, and feel OK upon entering cabin of parked car.

### Group 2:

1. A film or tint on windows reflects almost all of sun's energy (if tint is mirror-like). Disadvantage is that sun's energy is wanted in wintertime. Also, some films are hard to look out of under certain light conditions. In its ideal form, we would use glass that darkens and blocks sunlight energy as sun gets brighter as done in some polarized glasses. One possibility is to have separate mirror-like panels that cover the windows in summer only. These would attach conveniently and robustly, yet allow for easy cleaning.

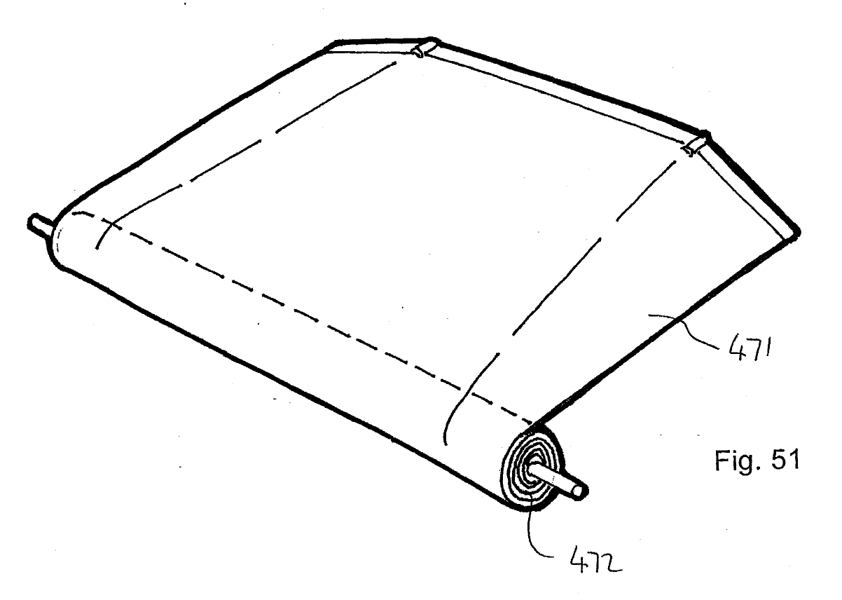

2. Ideal in preventing sun's energy from entering cabin is to cover windows from the outside with an opaque material ideal is a highly reflective, mirror surface that reflects 100% of incident rays, as shown in FIG. 51. In this light, our invention is to conveniently accomplish this every time car is parked and covering windows is deemed advantageous. In winter, this cover could prevent frost, and also act as an insulating blanket that helps maintain heat within the cabin. So the cover is insulating, and reflective in both directions. The cover 471 rolls up on a wide, small diameter roll 472 in the front of the vehicle under the hood. The hood tips open forward to expose the roll, and allow the blanket to unroll to rear of car, where it is attached. The cover is similar to how ordinary pull-down blinds work in windows, but more robust, and working horizontally within the car covering all top windows from front to rear. The cover additionally incorporates flexible solar panels that charge the car's on-board batteries when parked. Use is relatively convenient, but naturally less convenient than doing nothing (as traditional car) and walking away and just turning AC on full blast upon return. Some people nowadays inconveniently unfold reflectors inside car windshield, which is largely ineffective as it is on inside of car, letting heat into car, as opposed to outside where it should be placed to be most effective.

The roll-out device typically is NOT used in moderate weather. On really hot days, cover is used, or interior becomes an inferno In winter, on cold NIGHTS, it is used in order to prevent scraping of windows. In winter, the cover is NOT used during daytime when we WANT winter sun to warm cabin. In winter, cover IS used if car warmer is plugged in when the cover then reduces load on car warmer by acting as insulating blanket.

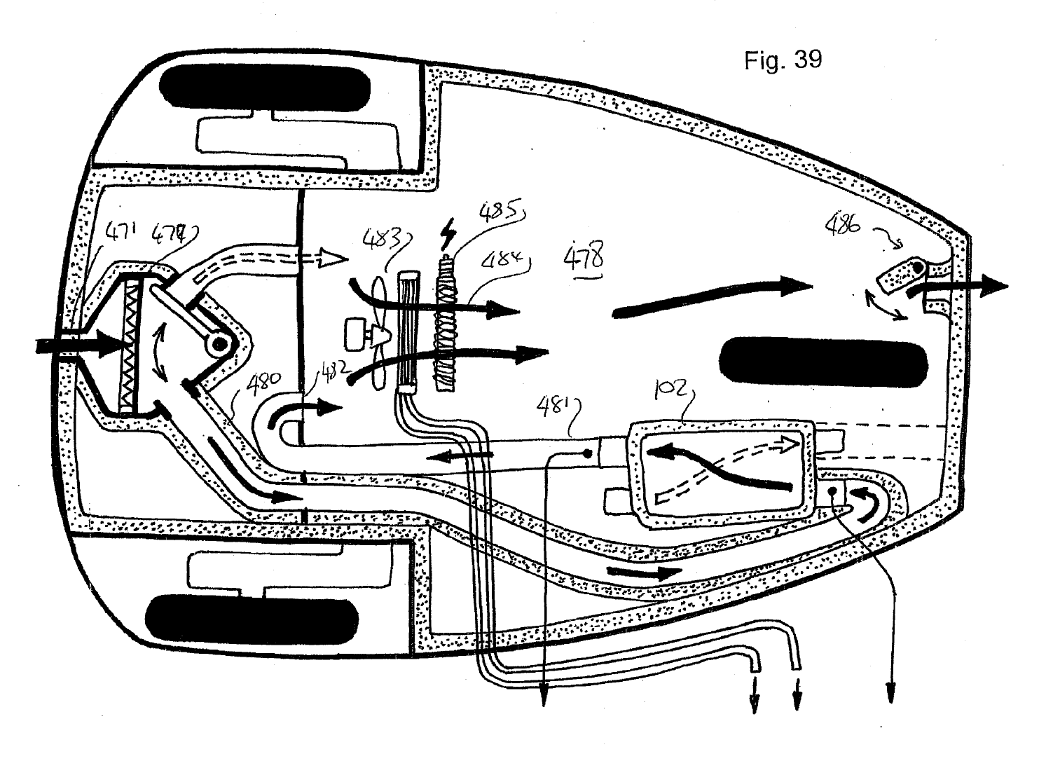

Turning now to FIGS. 38 and 39, in conjunction with FIG. 3, in both drawings, dotted areas show insulation, thicker arrows show air movement, dotted arrows show possible air movement or ‘other’ air movement and thin arrows just join both drawings together.

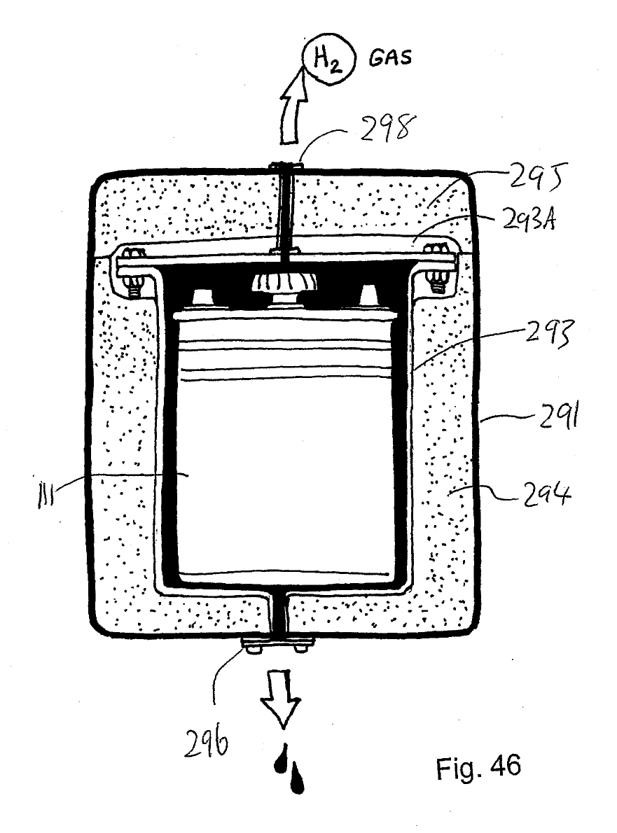

In FIG. 38, air enters in front of car at opening 471, goes through an air filter 472, and enters insulated a powertrain compartment along arrows 473. Air enters the battery compartment 291 if necessary, getting its air from the Powertrain Compartment and driven by a fan 474. The battery compartment has its own fan 474 and flap system 475 that can either circulate air or make the battery Compartment largely sealed off except for Hydrogen gas bleed line 298 (FIG. 46). The battery Compartment has its own independent temp. control system (as shown separately). The battery Compartment is its own insulated chamber located within the insulated Powertrain Chamber so that it is double insulated. This is done because Battery Temperature Control is critical for optimum battery performance and life (for lead-acid technology). Air in the Powertrain Compartment continues to the rear of car along arrows 476 and passes over all heat generators such as the motors, and increases in temperature as it moves to the rear of car. No fan is shown, but one could be added to assist in moving this air to the rear of car.

The IC engine 100 picks up air from the Powertrain Compartment. This could also be changed to pick up outside air for IC engine (to pick up ambient air). But for simplicity, shown this way. Air is burned in the IC engine 100 and leaves as exhaust gases 101. The engine 100 is largely insulated for pre-warming and for maintaining catalytic converter temperature, and for recovering exhaust heat for use in Cabin Compartment. The powertrain air 476 continues to rear of car, picking up heat from anything and everything in powertrain that generates heat. The air then all enters an air-to-air heat recovery unit HRV 102 or air-to-air heat or cool exchanger, as sometimes one recovers cooling within exhausting air.

A fan in HRV 102 exhausts all Powertrain air to rear of car and to outside through a discharge 103. A small water tank 104 and pump 105 can introduce a water spray into exhausting air. This evaporates within HRV 102, if exhausting air is hot and dry and can absorb water as the air is heated up in powertrain.

This water evaporating cools the exhausting air 103, hopefully below ambient, so that incoming cabin air can become cooler than ambient. For summer operation, and not shown, the air entering HRV from the powertrain could come directly from the nose opening 471 (so air entering HRV is starting with ambient air), and powertrain air 477 could exhaust directly outside at rear with a control flap (not shown). This summer mode would more likely result in cooling air entering the cabin when using evaporative cooling in HRV 102, and make exhausting heat from powertrain more efficient as it is not needing to go through HRV 102. In summer mode, we do NOT want to recover any powertrain heat. We want to dump it all to outside.

In FIG. 39, the cabin compartment 478 is completely separate and isolated from the powertrain and battery compartments. Within the car, it sits approximately above these other two compartments. The top of the cabin compartment is almost all glass, so temperature control in the cabin is very difficult, and must be very carefully handled. Without using the cover described previously, temperature variations within cabin can be extreme, and overpower ability to maintain comfortable temperatures with systems described here. Using the cover can keep extremes within limits, and starting temperatures controllable.

Cabin air enters in front 471 and goes through a further filter 479 which is completely separate from powertrain inlet and filter 472. Air can enter cabin directly or goes through insulated duct 480 toward HRV 102. A fan pushes inlet air through HRV 102 and tries to pick up temperature of exhausting air whether that be warmer or cooler than ambient. Regarding temperature of incoming air, this is best we can do using HRV 102 to getting inlet air away from ambient and closer to a comfortable temperature whether that be heating or cooling. This air enters cabin through a dust 481 and inlet 482 and a fan 483 pushes air over occupants at arrow 484. We can heat this air further by using a heating coil 485 from the IC engine exhaust 101, or from an electrical heater using battery bank energy. Cabin air 484 then passes over occupants and is exhausted through flap 486 at rear of cabin. This flap is wide open when cooling is desired, and largely closed or almost closed when heating is required.

In summer, winter, and spring & fall operation, in spring and fall where there are perfect ambient temperatures, the battery and Powertrain compartments are wide open and pass all air from front to back. The HRV is not used. Cabin air washes over occupants from front to back. No heating or cooling needed. Temperatures throughout car are as follows:

Cabin: Ambient throughout

Battery: Ambient throughout

Powertrain: Ambient at front of car, and Hot at exhaust flap at rear as it exhausts car.

In winter, we want heat, and we minimize heat loss, and maximize heat recapture. When car is plugged into wall socket, the insulated cover is on the windows, in-car heater keeps cabin warm and battery compartments are warmed by charging and/or built-in heaters. As one enters car, the cabin is warm, and batteries are warm. When car is parked outside, overnight, not plugged in, under these conditions, cabin and powertrain reach 40 below, but batteries maintain their own warmth by self-powering heating elements. The batteries stay warm.

As car starts to drive, the engine is pre-warmed by battery bank, IC engine starts, and heat is available for cabin from exhaust.

If battery bank is charged enough, instant electrical heat can enter cabin through coil, seat and steering wheel warmers. In this way, cabin warms from 40 below if left outside overnight not plugged in. If left plugged in, the cabin starts warm, and the car can likely maintain this temperature with heat inputs as just described.

As car is driven over some time, HRV 102 heat starts to play a role, recovering powertrain air energy as it exhausts through HRV.

Temperatures throughout car are as follows:

Cabin: Starts warm if plugged in, Warms quickly if battery elements used, Warms quickly if IC engine started. Warms slowly if just waiting for HRV heat, but eventually HRV can likely maintain heat within cabin.

Battery: Plugged in or self-warming, batteries maintain ambient temperature under coldest conditions. If not plugged in, batteries monitor their own energy and give up keeping warm at optimum depletion point.

Typically, battery compartment flaps are closed, and minimal air exchange is occurring within battery compartments. Battery boxes are essentially sealed (except for bleed air).

Powertrain: 40 below at front, and ideally close to that at exhausting air at rear, as HRV tries to recover all heat from powertrain cavity.

In summer, we must reject all heat. We do not want heat, and maintaining ambient (although Hot) is about the best we can do except for evaporative cooling. Worse condition is if we cannot reject heat, and ambient starts to climb towards unbearably hot temperatures. Also, in some areas, elevated temperatures with high humidity causes huge discomfort, but here again maintaining ambient is the best we can do. Under high humidity, evaporative cooling is largely ineffective, as is washing air over the skin. So, these are very uncomfortable conditions, but made worse by higher-than-ambient temperatures. So, again, maintaining ambient is the goal in summer. HRV 102 is only used for evaporative cooling. HRV 102 picks up powertrain air from front of car so air entering HRV 102 is ambient. Powertrain air is exhausted as quickly as possible to outside, through flap at rear (not shown).

Cabin air picks up outside air, or perhaps HRV air if cooler than ambient through evaporative cooling.

Batteries are wide open, fans running, trying to maintain ambient within battery compartments.

Temperatures throughout car are as follows:

Cabin: Starts close to ambient if cover used over windows. Warms quickly in sunlight if cover not used.

Fan in cabin, running directly on small solar panel, exhausts cabin air and tries to maintain ambient in direct sunlight (with or without window cover on). HRV evaporative cooling air used in low-humidity conditions.

Battery: Batteries maintain ambient temperature under hottest conditions.

Typically, battery compartment flaps are wide open, and maximum air exchange is occurring within battery compartments.

Powertrain: ambient at front, and very hot exhausting air at rear, through flap at rear (HRV not used for heated powertrain air).

### Battery Compartment as a Controlled Crashworthy Crush-Zone

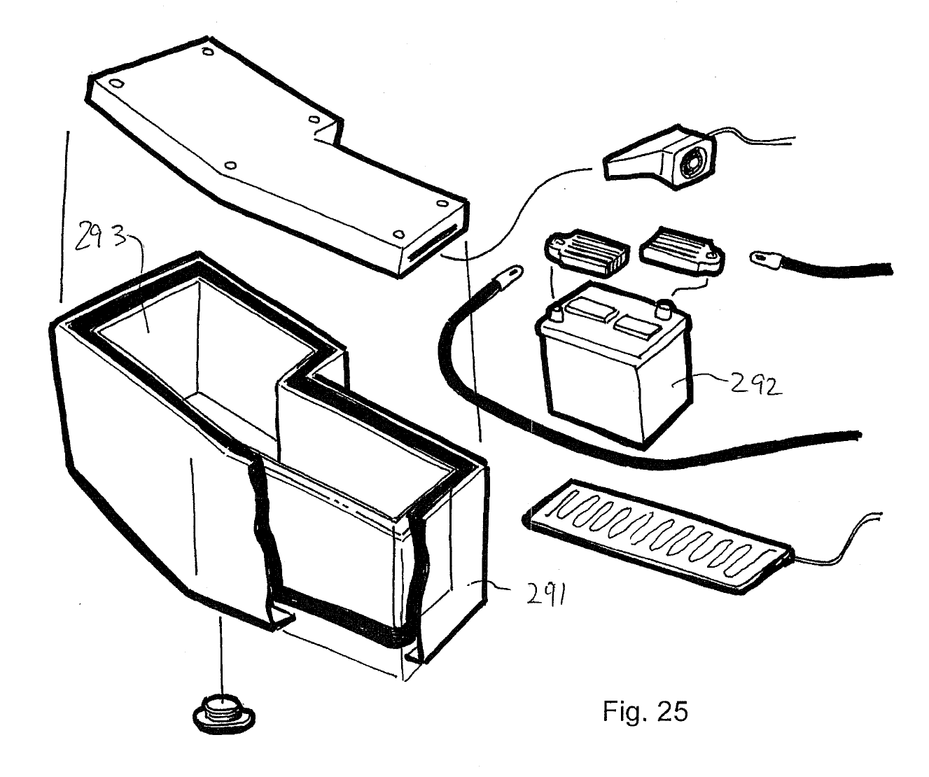

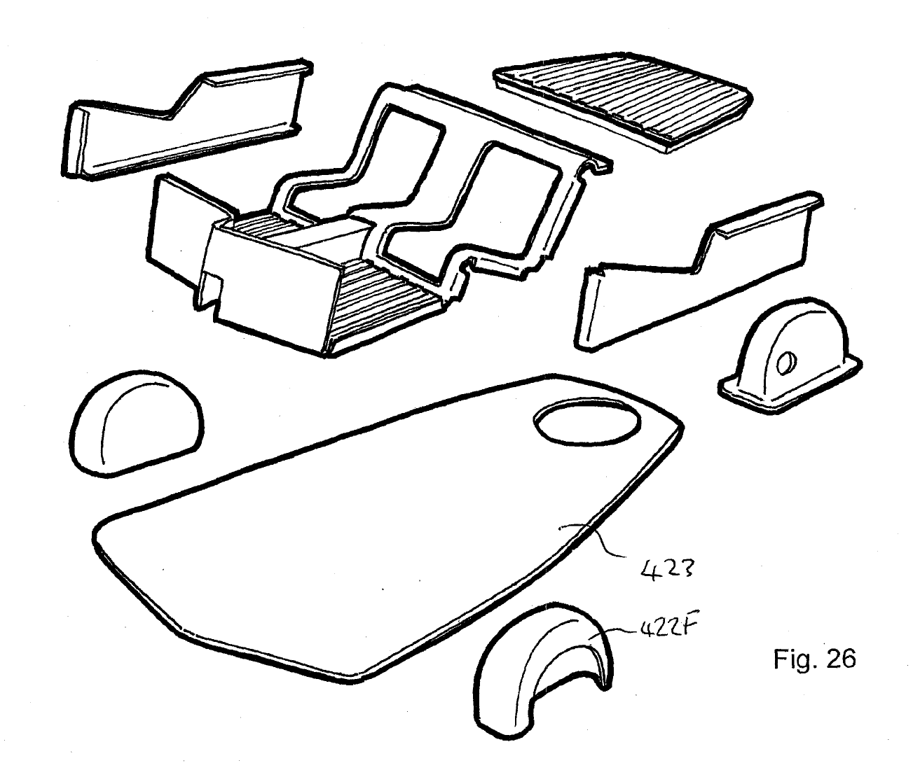

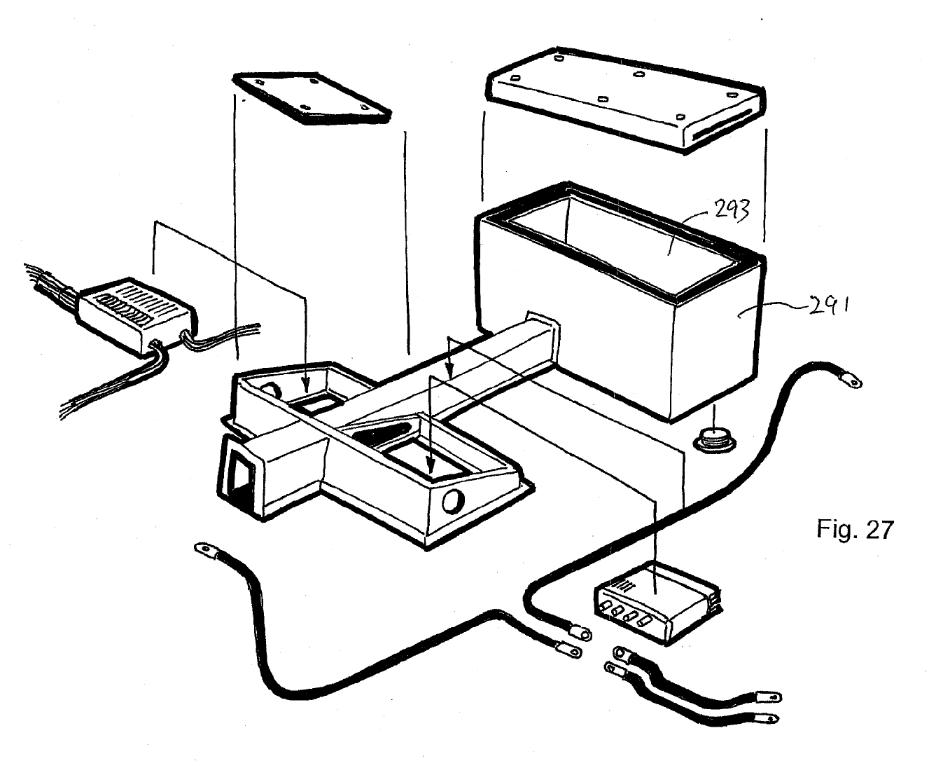

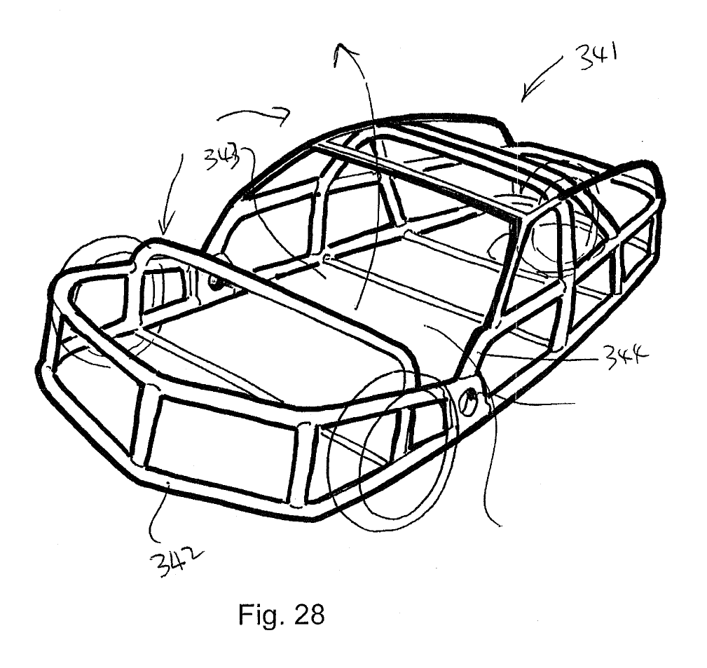

As shown in FIGS. 25, 37 and 45, the front mounted battery compartment 291 is an effective barrier between the passengers and the object being hit, allowing a more controlled deceleration that minimizes g-forces on the passengers. The vehicle is designed to crush controllably under crash conditions. The battery banks 292 are a concern in that they are at the front and mid-position of the car. Using the front battery bank as an example, there is a significant crush zone located ahead of the battery bank containing box, and this crush zone is heavily supported by a front section 342 of a rigid framework 341 as shown in FIG. 28. So, every attempt is made to not crush the battery bank box 291 in case of collision. However, under more severe crashes, before intrusion into the passenger compartment occurs, the battery bank box 291 gets crushed. In designing for this, the batteries themselves are contained in a steel box 293 within a surrounded crush material 294, and 295 as a cover, which also doubles as insulation for the battery box. So, this outer layer of battery box insulation 294 crushes first, after the car's chassis safety crush zone and barrier has been breached. This leaves the inner battery box 293 still intact. With larger and larger crash forces, this inner battery box crushes, which crushes and ruptures the batteries, which still absorbs lots of impact energy saving the passengers from these violent loads. The inner battery box 293 is designed to remain intact (leak-proof), by using a pliable metal. The liquids contained in this box, with increasing pressure, are designed to blow out the bottom through a vent 296 (FIG. 46), to the concrete below which is the safest place for this acid, if loads this high are reached. In this way, the batteries are safely utilized as a barrier that can safeguard the passengers. But the batteries are themselves protected, so this is only enacted at very violent accidents. Batteries are heavy and it is important to decelerate the mass of the vehicle at the onset of a crash, instead of having it pile up behind the occupants as if the battery weight was all in the rear of the car in a head-on crash. So, front placement has this advantage, similarly to a front-engine car since most cars are now front-engine because most crashes are front-end crashes.

### Passenger Ergonomics

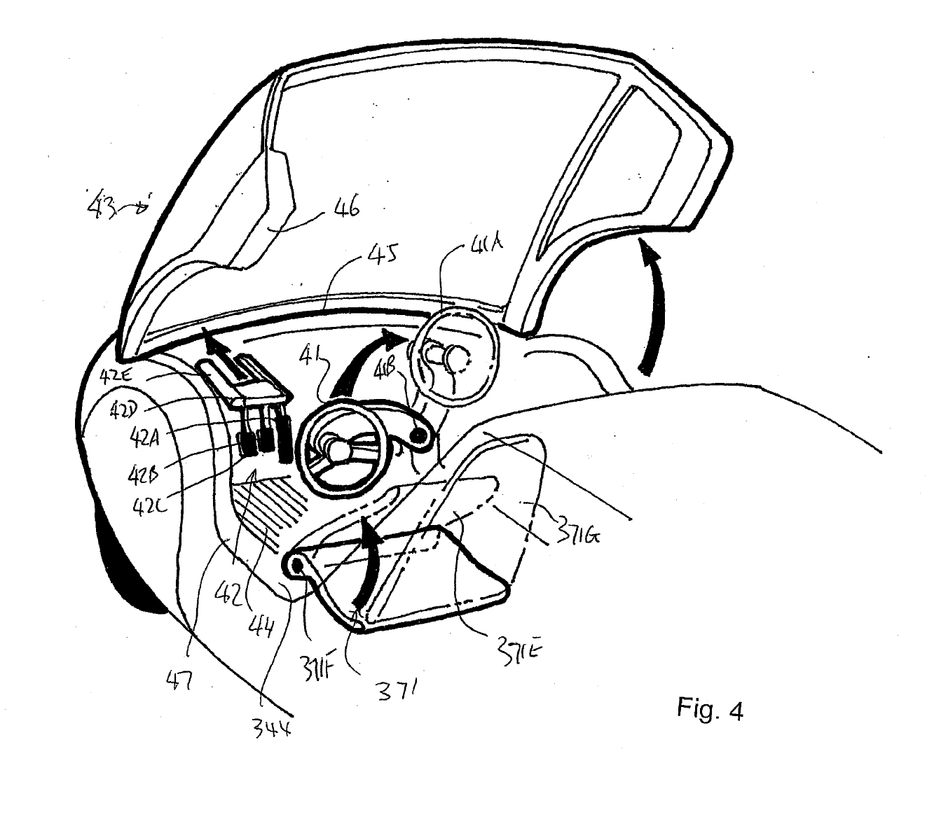

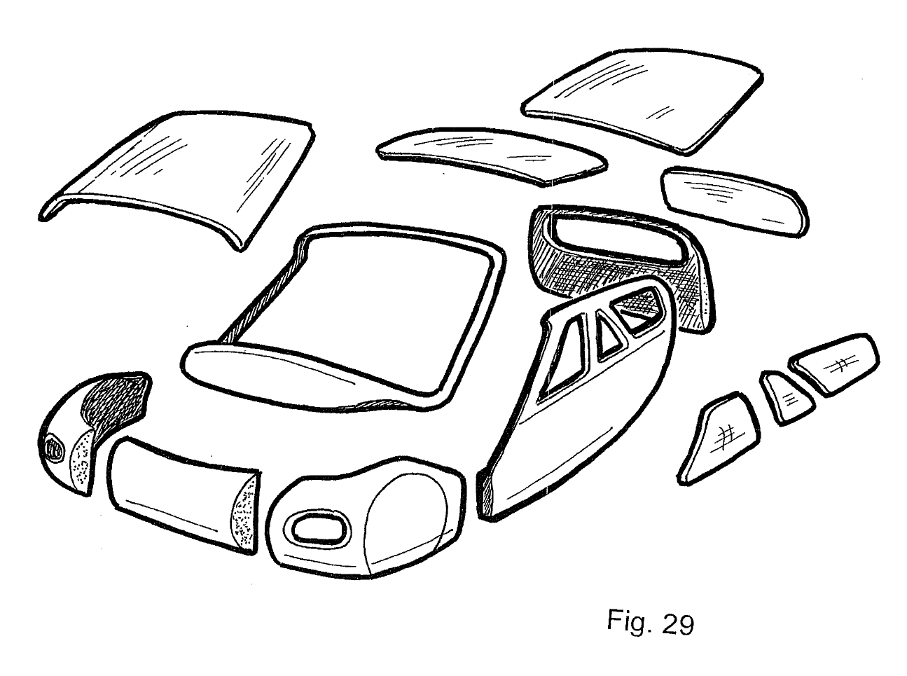

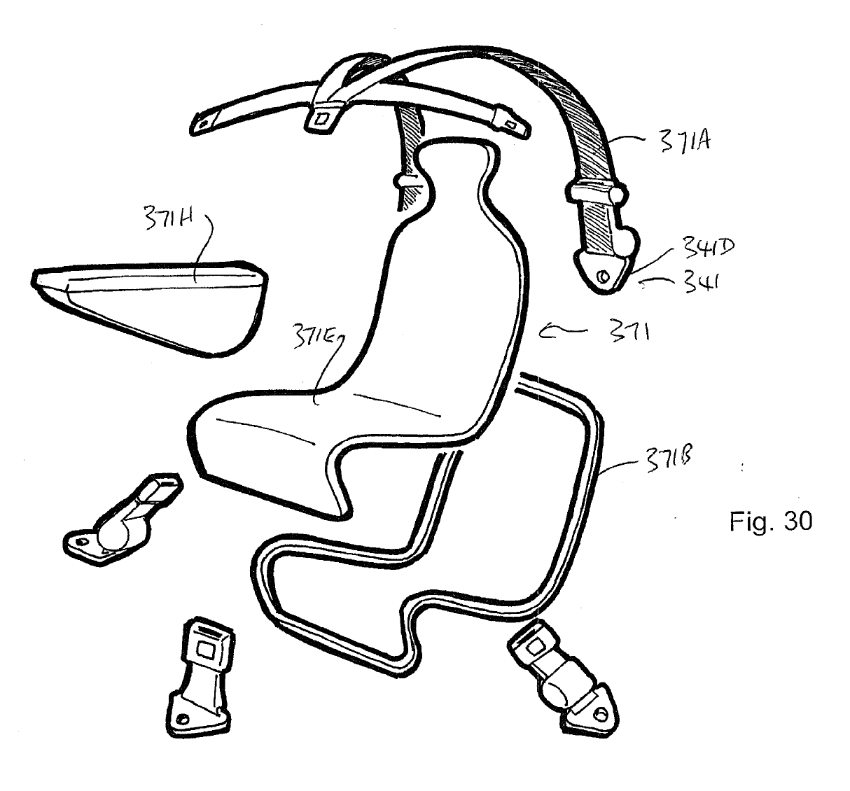

Turning now to FIGS. 4, 24, 28, 29 and 30, there is described as follows how people enter and exit the car. This involves the following components: the passenger compartment 343 defined within the outer frame 342; seats 371; steering wheel 41; pedals 42; door 43 and floorboards 44. These areas needed to be different and innovative because the vehicle herein is a very low car.

The vehicle herein needs to be a low car because any unnecessary car height adds to the frontal area and therefore increases air resistance, which demands more energy for movement. So the vehicle herein is as low as practical. The lowest production car ever to legally be on public roads was the Ford GT-40. So named because its highest point was 40 inches above the pavement. The vehicle herein is 40 inches high as well. And in being this low, there is history that this height was practical on existing roads. It is this rather low car that necessitates an innovative way for entering and exiting the passenger compartment. The Ford GT-40 needed large cutouts in the roof that were attached to the side doors. These cutouts were absolutely needed so that a person could get into and out of the GT-40.

The vehicle herein will fit tall people and may, like the new Ford GT, have to be slightly higher than 40 inches (in the 40 to 43 inch range). But regardless, this is a low car.

Full canopies that tilt forward is another common strategy of entering a low car as opposed to cutouts in the side door. Full canopies allow the passenger enough room to enter car from the top as opposed to side doors that require entry from the side. The vehicle herein uses a full canopy that tilts forward, but with significant differences. These differences came about because we built a full-scale wooden mock-up and designed the vehicle herein to easily accommodate most people.

The special unique features of the vehicle herein are as follows:

The door 43 is a full width canopy (single door) that hinges at the front 45 and opens to near vertical or past vertical. In open position, the canopy is completely out of the way so that a person, while standing vertical not bending down or leaning over, can step into car over the side frame 344. The canopy 46 is cut low on side of car so as to provide low threshold 47 for person to step over upon entering car, that is the person must step over the frame rails 344 of the frame 341 So, the first step in entering car is:

canopy opens, and person steps into car while maintaining standing-up position.

Stepping over side of car is made as low as possible by design through cutout 46 that goes up with canopy.

Stepping over side of car can be made lower by also lowering air suspension of car upon entry and exit.

Stepping into the vehicle from a curb (as opposed to from road) makes this initial relative step lower again.

Regardless, the initial step is easy for most people to navigate as it is not a high or wide step that is required. The vehicle herein frame is narrow here, in comparison to the GT40.

The Floorboard 44 is arranged relative to the seat 371 so that the first step is directly onto the flat floorboard in front of the seat. The feet are nowhere near the seat.

On many exotic cars, the first step into the car places feet on the seat cushion of the car, or has feet very near to seat cushion (gliding close to and over seat as it finds the floorboard). This is completely impractical as a daily runner of a car, and can only work in sunny-day drivers which is what most exotic cars are. One must imagine muddy boots and entering a car and sitting down with extremely filthy and wet shoes on, a common occurrence with regular cars.

One steps from roadside, over a threshold, and into car, finding oneself standing upright in car, with both feet located on flat floorboard, basically facing forward, ready to sit down onto seat.

Note that the vehicle herein floorboard has floormats that capture dirt and grime in traditional manner and restrict this filthiness to floorboard, and off of seat (a very important criteria in a daily-use car).

To accomplish this, a few other things have to happen before one enters the vehicle. For the driver of the car, the steering wheel is usually an obstruction to get around for entry and exit.

In low, exotic cars, this is especially true, and requires some dexterity to get into and out of car (as opposed to the passenger that has no steering wheel in the way). For very tight, low cars, the steering wheel makes it impossible to enter car and must be removed upon entry and reinstalled once person is seated (Formula 1 cars as an example).

The vehicle herein has the steering wheel is designed to pivot about an axis 41B longitudinal of the vehicle and offset from the rotation axis of the wheel by an arm 41C completely out of the way upon entering the vehicle. The out-of-the-way position 41A is up and in the centre of the car as shown at 41A, where it is not in the way at all of driver or passenger. The canopy MUST be open for the steering wheel to pivot out of way, and steering wheel must be down for the canopy to close.

As shown in FIG. 24, the steering is never lost as steering wheel pivots because mechanism stays intact, and pivots about one sprocket 41D on chain 41E used to steer. So, as steering wheel pivots out of way, the steering wheel rotates as the steered rear wheel stays stationary, but no disconnection of steering mechanism occurs which is a very important safety consideration. To be clear, at any position of steering pivot, one can steer the rear wheel. So, with The vehicle herein, upon entering car, canopy opens and then steering wheel pivots completely out of the way to higher, centered position within passenger compartment.

The seat 371 within the vehicle herein does NOT adjust back and forth, but is fixed in position on a frame 371B relative to the frame of the car. This is done for safety of passengers where it is better to be in a seat rigid to the frame 341 of the vehicle, and because the car's mechanisms are all tightly located underneath seat because space is a premium in a tiny car. The fixed seat allows the seatbelts 371A to attach to the frame 341 by a bracket 341D directly, as opposed to attaching to seat which must take crash loads into chassis through seat adjustment mechanism. The fixed seat is also done so that entry pathway remains the same and is predictable. For example, if you're a big person getting in car where the seat is placed all way forward, this is awkward.

The seat lower cushion 371E can and does move, by hinging at front 371F where person's knee is so that the rear of horizontal seat cushion move upwards from rest position. This movement of lower cushion allows person to be lowered or raised from a very low seating position which is necessary because of the lowness of the car. It is very difficult for especially older people to get up from a low seating position. This is similar to standing up from sitting on the floor. Most older people will turn over before getting up, and use arms and legs to achieve vertical.

In the car, we want the person to just raise themselves from seating position to a standing position and end up facing forward that is the same direction they were seated. To do this from seated position in car, the torso must first achieve vertical (easy to do from reclined seated position, the torso pivots around the hips and person is seated vertical on car seat. Next, from this position, or in parallel to raising torso, the legs are brought into body by bending the knees and bringing the feet slightly under front of seat or as close to seat as feet can fit while both feet stay flat on the floor. This foot location is no different as when getting out of a chair. If feet can go slightly under chair, it is much easier getting up, as opposed to many full sofas that don't allow your feet or legs to go under the sofa. In that case, a sort of ‘rocking and projectile’ method is needed to get up from the sofa as opposed to a smooth lifting of the body out of a chair. That is because in the case of the sofa, one must get through a body position that can not be maintained because of gravity and non-equilibrium. In this case, the body's centre of gravity cannot be maintained between sitting position and standing position due to the sofa's design.

So, in he vehicle herein, in getting up from a very low sitting position, we have similar issues to a sofa. Those that get up from the floor while maintaining a forward orientation are able to get their feet right underneath their body and then lift themselves up, while maintaining a stable centre of gravity position all the way. With the seat arrangement herein this is not possible. The best we can do is get feet right at, and slightly under, the base of the seat. And best the torso can do is lean well forward, but the body of the person is still well rearward of feet.

After this, in order to lift body to standing position in the car, the passenger has these choices:

a) rock and jerk and projectile body into stable position getting bum up and out of seat, young fit people can easily do this, older people cannot, especially if they are obese as the torso cannot lean well forward.

b) use handles appropriately placed in car and pull body into stable position using strength of arms, young people do not need handles, older people can use them as crutches, but are band-aid design-wise to the real issue.

c) the seat cushion can, by pivoting at forward location, and by being powered upwards thus doing the lifting, can actually raise bottom and torso into a stable position without effort from person.

It does this while maintaining the person's feet on the floorboard, and pivoting upper and lower leg limbs together around the ankle, and largely unfolding the legs at the knee as the rear of the cushion is raised. If the feet are not located at the base of the seat, the raising of the bum will not achieve a stable position, and it will be awkward. But, if done correctly by the person, the motion is fluid, stable, and effortless.

So, for this reason it's design must be more exact and the person must do every movement correctly in order to achieve effortless motion while getting up and out, or the reverse (getting into seat).

The seat cushion can be powered by air, electrically, or mechanically spring loaded. Power can be full that is greater than body weight or just assist still requiring some pulling up from person while using handles. Power up and power down are required as a movable bottom cushion is used in both getting up and getting in.

Variations include that just the seat cushion pivots or that just a bar at bottom pivots up and pushes on the bottom only. The bar can fit neatly between the horizontal cushion 271E and the seat back 371G. Alternatively, the entire seat pivots up, and the backrest 371G hinges flatter relative to the seat base 371E so the person can become erect, or else the seat backrest would force person in hunched position. Alternatively, just armrests 371H pivot up, and upper arms are used as supports needing no effort from person. A handle on the door 43 pulls the person vertical, as the door powers open. Similarly for lowering the person so that the person is just hanging from handle, not needing to exert muscle effort.

The pedals 42 on the vehicle include the acceleration pedal 42A, brake pedal 42B, and regeneration pedal 42C. This is rather unique: having a separate regeneration braking pedal, but this is better than integrating it with brake pedal or accelerator pedal. More typical is having regeneration being automatic when acceleration pedal is lifted or when brake pedal is depressed slightly. However having a separate pedal 42C for regeneration only, and putting it to far left where clutch pedal is usually on a standard transmission car, has these advantages:

Technically the simplest and most straightforward regarding machine design. Therefore it is easy for driver to understand what this third pedal does.

Acceleration pedal does only acceleration and is in full freewheeling mode with pedal fully lifted allowing use of coasting, the most energy-efficient way to recover kinetic energy and turn it into distance. So, for driver this is also easy to understand, regarding energy-efficiency try to use acceleration pedal as little as possible and coast freewheel as much as possible.

Pushing this pedal uses up precious energy in getting and keeping car moving, lifting this pedal all the way is the best way to recover some of the energy used to get car moving.

The brake pedal just activates service brakes which are conventional hydraulically actuated disc brakes. The driver must realize that this pedal stops the car at any time, but that energy-wise it is the least desirable option. All energy due to car movement goes to heat when this pedal is used. All energy is wasted and gone forever.

The regeneration pedal activates the coil in the alternator and initiates regeneration, from partial to full-on. The large stroke of the regeneration pedal allows fine tuning of the amount of regeneration selected at any time. Also, to the driver, the function is distinct from the brake pedal. The regeneration pedal as it is depressed decelerates the car significantly so that one can feel it, up to a maximum, but it is clear that this is not the service brake.

So, during emergencies, as in a standard transmission car which has a similar third pedal as a clutch, the driver punches the brake pedal involuntarily and instinctively. But during normal driving, the driver learns that, after coasting, the regeneration pedal is the best way to try and slow the car down relatively rapidly even though only about 20% of energy is recovered, this is still better than the 0% for the brakes.

With training, one could drive in city traffic and hardly ever use the brake pedal, that is the goal in driving with optimum energy-efficiency in mind would be to coast to a stop most of the time. The three pedals are on a moving carriage 42D that is powered forward by a drive system 42E and backward along a track. The carriage is powered either by air, electrically, or manually adjusted. This offers adjustment for different sizes of people, since the pedals must move back and forth since the seat is fixed in fore and aft position. The carriage is typically powered so that it can move full forward and get out of the way during entry or exit, so that it clears the floorboard for person to step into and out of car. Once the person is seated, the pedals on the carriage 42D return to required or pre-set position.

In regard to the passenger compartment, as can be seen, these components described all act together to make entry and exit into car as fluid and effortless as possible. Solutions need to be unique because this extremely low seating position is typically not used for a mass market car. It is also possible that even the seat belts 371A are fashioned within a more rigid framework in a way more like some theme ride restraints whereby they pivot up to let person in and pivot down and lock once person is seated. Theme rides have led the way (roller coaster rides that go upside-down come to mind) in making restraints fast, convenient and secure. In its eventual form, entry into the vehicle can be as an ‘unfolding’ of the components described above like an opening flower, the person or people get in, and a closing up of the flowering components into a tight aerodynamic shell of a car. Most if not all of these components can be powered and somewhat automatically timed. So, person walks up to car, all this unfolding occurs, person gets in, folding up occurs, and person drives off.

This technology is more difficult than existing cars, with their simple side door hinged at the front, and nothing else really required, but then this low seating is a far more necessary driving position if one wants to move on way less energy. Over the life of the car, the savings are worth it.

So, as one walks up to the vehicle, this is what typically will happen:

1. Person turns key, pulls handle, or uses remote to tell car he wants door to open, that he wants to get into car.

2. Canopy door opens upward and forward to vertical position. Canopy door is no higher than typical standing person, so works in all parking garages, where people can walk without bending over. Canopy opening is unaffected by how close one is parked next to another car, as are side-opening doors. In rain, canopy lets in rain, so no option here but to hurry up. Seats in the vehicle are self-draining as in exposed farm machinery seats, so at least they can't pool water in rain and canopy open.

3. As the canopy opens, the steering wheel moves up and out of way, pedals move forward, seat belt frame pivots upward, and seat cushion gets into place (if not there already).

4. Seat cushion typically remains vertical from last exit, and that is the way it will be upon entering vehicle. Position of seat cushion can be fixed in car, or powered up or down as required, or made inactive, all dependent upon what seat is used for (especially passenger seat which can hold luggage).

5. Person steps into car over low, narrow chassis threshold. Person stands upright facing forward. Both feet flat on floorboard, close to front of seat cushion.

6. Person leans back onto raised seat cushion and allows bum weight to start weighing onto cushion.

7. Car senses by the weight on cushion or other means (perhaps a ‘close’ button) that person is ready to initiate closure. Safeguards are required that this automatic feature is not initiated until it makes sure everyone driver and/or passenger is ready for what is about to happen.

8. Closure is initiated and carried out: cushion lowers, steering wheel returns, canopy closes, and pedals move forward to pre-set position or until resistance is met by feet.

9. Seat belts come down before canopy closes or are fastened by operator once seated.

10. Car is ready to drive off.

The vehicle herein design lends itself well for easy conversion from left hand drive to right hand drive. This can easily be done at the factory level, or even dealer level, with a few different components that are replaced. The steering mechanism is predominantly centred in the vehicle and the pedal cluster is a unit. This is what makes this conversion easy. Process would be to move pedal cluster to opposite side (easy because it is just connected by electrical lines and hydraulic brake lines. Steering pivoting unit would be a different unit as a mirror image but would just bolt onto centre console. These are all the changes necessary, as we visualize a symmetrical control and instrument panel within this car. If a few controls are asymmetrical about centerline of car, then these would easily move to opposite side.

1. A vehicle comprising:
a vehicle body defining an enclosure of one or more passengers;
ground wheels including at least one non-steering ground wheel and at least one steering ground wheel;
a power generation system;
a power transmission system from the power generation system to one or more of the wheels;
the body including rounded upper and lower side-edges of body, allowing sharing of air between four sides of car body as air travels over body, from front to rear.

2. The vehicle according to claim 1 wherein the steering ground wheel is located at the rear which allows two non-steering front ground wheels to be close to the outside edge of body, giving the car a wide stance.

3. The vehicle according to claim 1 wherein steering ground wheel has a tire which projects through only a slot in a support disk with the entire disc with the slot in it rotating about an upright axis in order to steer.

4. The vehicle according to claim 1 wherein front wheels are non-steering and are covered on the sides to a position at the bottom of the body.

5. The vehicle according to claim 1 wherein a cam provides self centering of the steering ground wheel.

6. The vehicle according to claim 5 wherein cam pressure of the cam is adjustable to reduce self centering at low speed.

7. A vehicle comprising:
a vehicle body defining an enclosure of one or more passengers;
ground wheels including at least one non-steering wheel and at least one steering wheel;
a power generation system;
a power transmission system from the power generation system to one or more of the wheels;
wherein the generation and transmission system comprises a hybrid drive system including an IC engine, electric motors where the electric motors are sized for acceleration and low-speed cruising, while the IC engine and fuel tank therefor are sized for high speeds and long-distance driving.

8. The vehicle according to claim 7 wherein the electric power is stored in a combination of batteries and ultra-capacitors.

9. The vehicle according to claim 8 wherein the ultra-capacitors absorb energy primarily during regenerative braking and on downhill runs, and they release this energy during vehicle acceleration or hill-climbing.

10. The vehicle according to claim 8 wherein the ultra-capacitors buffer the current seen by the batteries, making the batteries last significantly longer before needing replacement.

11. The vehicle according to claim 7 wherein the engine is used either to drive a generator for electric storage or to directly drive one wheel for long distance cruising speed travel and the electric motors are used for acceleration and low speed travel.

12. The vehicle according to claim 7 wherein he electric motors each drive one wheel though a chain drive and the IC motor drives one of the wheels through a chain drive.

13. The vehicle according to claim 7 wherein the engine and emission system is pre-heated from stored electrical power so that the engine starts at efficient warmed condition.

14. A vehicle comprising:
a vehicle body defining an enclosure of one or more passengers;
ground wheels including at least one non-steering wheel and at least one steering wheel;
a power generation system;
a power transmission system from the power generation system to one or more of the wheels;
wherein the body includes a full width door that hinges at the front 45 and opens to near vertical or past vertical;
wherein the canopy is cut low on side of car so as to provide low threshold for person to step over;
wherein the floorboard is arranged relative to the seat so that the first step is directly onto the flat floorboard in front of the seat;
and wherein a steering wheel is arranged to move from its position in front of the seat.

15. The vehicle according to claim 14 wherein the steering wheel is arranged to pivot about an axis longitudinal of the vehicle and offset from the rotation axis of the wheel.

16. The vehicle according to claim 15 wherein a linkage carrying the steering shaft includes an arm which can fold upwards to allow the driver to stand up from the seat for exit.

17. The vehicle according to claim 14 wherein the passengers are seated in a cage which extends in front of them, over their heads and to the sides of them which entrance through a door entry which lifts up allowing them to step over the sides of the cage onto the floor.

18. The vehicle according to claim 14 wherein the seat is fixed fore and aft.

19. The vehicle according to claim 14 wherein the seat includes a lifting seat bottom panel.

20. The vehicle according to claim 14 wherein the vehicle includes foot pedals for actuation by the driver where the pedals are mounted on an adjustable pedal carriage.

21-36. (canceled)
